(19) United States
(12) Patent Application Publication
(10) Pub. No.: US 2024/0413765 A1
(43) Pub. Date: Dec. 12, 2024

(54) POWER CONVERSION APPARATUS, MOTOR DRIVING DEVICE, AND REFRIGERATION CYCLE APPLICATION DEVICE

(71) Applicant: Mitsubishi Electric Corporation, Tokyo (JP)

(72) Inventors: Shinya TOYODOME, Tokyo (JP); Kazunori HATAKEYAMA, Tokyo (JP); Shoei TSUTSUMI, Tokyo (JP)

(21) Appl. No.: 18/704,161

(22) PCT Filed: Dec. 10, 2021
(86) PCT No.: PCT/JP2021/045576

§ 371 Date: Apr. 24, 2024

(51) Int. Cl. H02M 7/483

(52) U.S. Cl. CPC H02M 7/4835

(57) ABSTRACT

A power conversion apparatus includes: a converter that rectifies a power-supply voltage applied from an AC power supply; a capacitor connected to an output end of the converter; an inverter connected across the capacitor; and a control device that performs vibration reduction control of reducing vibration of a compressor by controlling an operation of the inverter. The control device includes: a γ-axis current compensation unit that reduces pulsation of a capacitor output current output from the capacitor to the inverter; and a γ-axis current compensation limiting unit that limits an excitation current compensation value generated by the γ-axis current compensation unit so as to reduce a harmonic component included in a power-supply current flowing between the AC power supply and the converter.

### CROSS-REFERENCE TO RELATED APPLICATION

This application is a U.S. national stage application of PCT/JP2021/045576 filed on Dec. 10, 2021, the contents of which are incorporated herein by reference.

### FIELD

The present disclosure relates to a power conversion apparatus for supplying AC power to a motor that drives a load, a motor driving device, and a refrigeration cycle application device.

### BACKGROUND

A power conversion apparatus includes: a converter that rectifies a power-supply voltage applied from an AC power supply; a capacitor connected to an output end of the converter; and an inverter that converts a DC voltage output from the capacitor into an AC voltage and applies the AC voltage to the motor.

Patent Literature 1 below discloses a technique for preventing an increase in vibration by appropriately compensating for torque pulsation, which is a pulsation component of load torque, in accordance with a state of a motor that drives a compressor.

### PATENT LITERATURE

Patent Literature 1: Japanese Patent Application Laid-open No. 2016-082637

In an air conditioner which is one of application products of a refrigeration cycle application device, in order to prevent failure due to a harmonic component included in a power-supply current, regulations on harmonics of the power-supply current are defined. For example, in Japan, Japanese Industrial Standard (JIS) defines a standard value that is a limit value for harmonics of a power-supply current.

However, the technique described in Patent Literature 1 does not take into account harmonics of a power-supply current. Therefore, when a compensation component for torque pulsation of the motor is generated at a frequency asynchronous with a power supply frequency by using the technique of Patent Literature 1, there is a problem that the power-supply current is brought into an imbalance state between positive and negative polarities, and a harmonic component of the power-supply current increases.

### SUMMARY

The present disclosure has been made in view of the above, and an object thereof is to obtain a power conversion apparatus capable of preventing an increase in harmonic component of a power-supply current while compensating for torque pulsation of a motor.

In order to solve the above-described problem and achieve the object, a power conversion apparatus according to the present disclosure is a power conversion apparatus that supplies AC power to a motor that drives a load. The power conversion apparatus includes a converter that rectifies a power-supply voltage applied from an AC power supply, a capacitor connected to an output end of the converter, and an inverter connected across the capacitor. Furthermore, the power conversion apparatus includes a control device that performs vibration reduction control of reducing vibration of the load by controlling an operation of the inverter. The control device includes: an excitation current compensation unit that reduces pulsation of a capacitor output current output from the capacitor to the inverter; and an excitation current compensation limiting unit that limits an excitation current compensation value generated by the excitation current compensation unit so as to reduce a harmonic component contained in a power-supply current flowing between the AC power supply and the converter.

The power conversion apparatus according to the present disclosure has an effect of preventing an increase in harmonic component of a power-supply current while compensating for torque pulsation of the motor.

### BRIEF DESCRIPTION OF DRAWINGS

FIG. 1 is a diagram illustrating a configuration example of a power conversion apparatus according to a first embodiment.

FIG. 2 is a diagram illustrating a configuration example of an inverter included in the power conversion apparatus according to the first embodiment.

FIG. 3 is a view illustrating a state of an operation without vibration reduction control in a motor driving device according to the first embodiment.

FIG. 4 is a view illustrating a state of an operation with vibration reduction control in the motor driving device according to the first embodiment.

FIG. 5 is a block diagram illustrating a configuration example of a control device included in the power conversion apparatus according to the first embodiment.

FIG. 6 is a first view for explaining a problem of the present application.

FIG. 7 is a second view for explaining a problem of the present application.

FIG. 8 is a block diagram illustrating a configuration example of a voltage command value calculation unit included in the control device according to the first embodiment.

FIG. 9 is a block diagram illustrating a configuration example of a speed control unit included in the voltage command value calculation unit according to the first embodiment.

FIG. 10 is a block diagram illustrating a configuration example of a vibration reduction control unit included in the voltage command value calculation unit according to the first embodiment.

FIG. 11 is a block diagram illustrating a configuration example of a γ-axis current limit value generation unit that generates a γ-axis current limit value, which is an input signal to a γ-axis current compensation unit according to the first embodiment.

FIG. 12 is a block diagram illustrating a first configuration example of a γ-axis current compensation limiting unit according to the first embodiment.

FIG. 13 is a flowchart for explaining an operation of a limit value calculation unit included in the γ-axis current compensation limiting unit according to the first embodiment.

FIG. 14 is a flowchart for explaining an operation of a second limiter included in the γ-axis current limit value generation unit according to the first embodiment.

FIG. 15 is a block diagram illustrating a second configuration example of the γ-axis current compensation limiting unit according to the first embodiment.

FIG. 16 is a waveform chart for explaining an operation of the γ-axis current compensation unit according to the first embodiment.

FIG. 17 is a flowchart for explaining an operation of the Y-axis current compensation unit included in the voltage command value calculation unit according to the first embodiment.

FIG. 18 is a block diagram illustrating a configuration example of a voltage command value calculation unit according to a modification of the first embodiment.

FIG. 19 is a flowchart for explaining an operation of the γ-axis current compensation unit illustrated in FIG. 18.

FIG. 20 is a block diagram illustrating a configuration example of a power supply harmonic standard value calculation unit included in the γ-axis current compensation limiting unit according to the first embodiment.

FIG. 21 is a view for explaining calculation processing of a current harmonic limit value calculation unit included in the power supply harmonic standard value calculation unit according to the first embodiment.

FIG. 22 is a block diagram illustrating a configuration example of an order component calculation unit included in the γ-axis current compensation limiting unit according to the first embodiment.

FIG. 23 is a block diagram illustrating a configuration example of a γ-axis current compensation limiting unit according to a modification of the first embodiment.

FIG. 24 is a block diagram illustrating a configuration example of a mechanical angular frequency component extraction unit included in a γ-axis current compensation limiting unit according to the modification of the first embodiment.

FIG. 25 is a view for explaining an effect of γ-axis current compensation control according to the first embodiment.

FIG. 26 is a view for explaining an action by γ-axis current compensation limiting control according to the first embodiment.

FIG. 27 is a diagram illustrating an example of a hardware configuration for implementing the control device included in the power conversion apparatus according to the first embodiment.

FIG. 28 is a diagram illustrating a configuration example of a refrigeration cycle application device according to a second embodiment.

### DETAILED DESCRIPTION

Hereinafter, a power conversion apparatus, a motor driving device, and a refrigeration cycle application device according to embodiments of the present disclosure will be described in detail with reference to the accompanying drawings. Note that, in the following description, the term “connection” includes both a case where components are directly connected to each other and a case where components are indirectly connected to each other via another component.

### First Embodiment

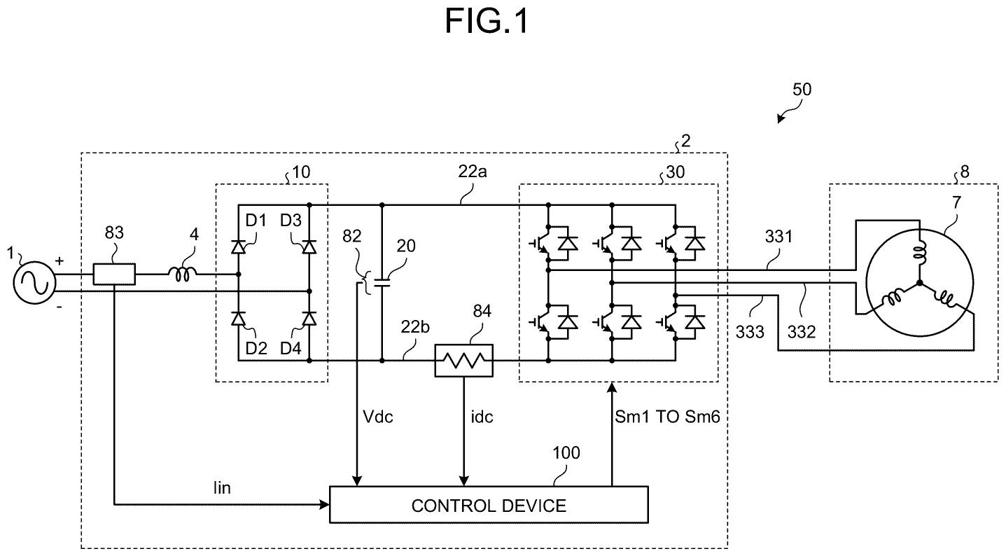

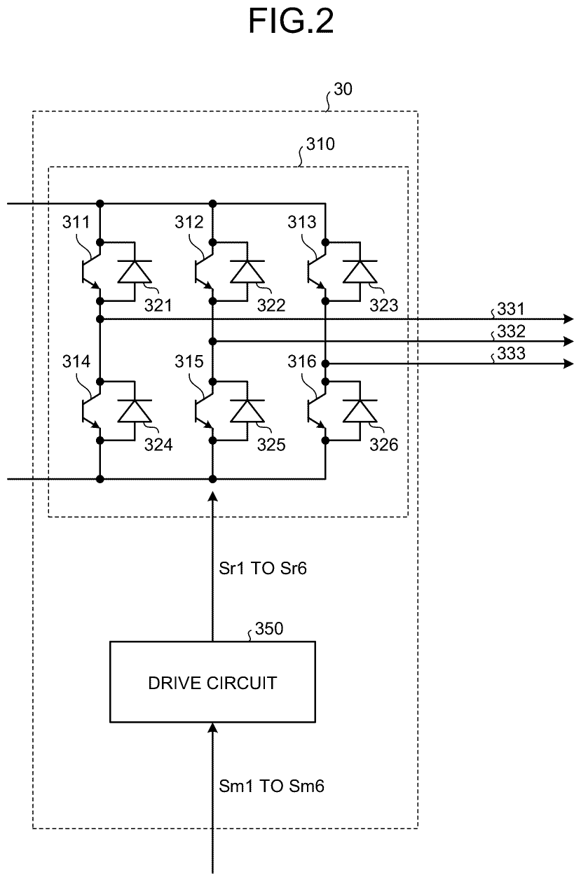

FIG. 1 is a diagram illustrating a configuration example of a power conversion apparatus 2 according to a first embodiment. FIG. 2 is a diagram illustrating a configuration example of an inverter 30 included in the power conversion apparatus 2 according to the first embodiment. The power conversion apparatus 2 is connected to an AC power supply 1 and a compressor 8. The compressor 8 is an example of a load having a characteristic that a load torque periodically fluctuates when being driven. The compressor 8 includes a motor 7. An example of the motor 7 is a three-phase permanent magnet synchronous motor. The power conversion apparatus 2 converts a power-supply voltage applied from the AC power supply 1 into an AC voltage having a desired amplitude and phase, and applies the AC voltage to the motor 7. The power conversion apparatus 2 includes a reactor 4, a converter 10, a capacitor 20, the inverter 30, a voltage detecting unit 82, current detecting units 83 and 84, and a control device 100. The power conversion apparatus 2 and the motor 7 included in the compressor 8 constitute a motor driving device 50.

The converter 10 includes four diodes D1, D2, D3, and D4. The four diodes D1 to D4 are bridge-connected to constitute a rectifier circuit. The converter 10 rectifies a power-supply voltage applied from the AC power supply 1 by using the rectifier circuit including the four diodes D1 to D4. In the converter 10, one end on an input side is connected to the AC power supply 1 via the reactor 4, and another end on the input side is connected to the AC power supply 1. Further, in the converter 10, an output side is connected to the capacitor 20. Note that there may be also a configuration in which the reactor 4 is connected between the converter 10 and the capacitor 20, that is, to the output side of the converter 10.

The converter 10 may have a boosting function of boosting a rectified voltage, together with the rectifying function. The converter having the boosting function may include, in addition to or instead of the diode, one or more transistor elements, or one or more switching elements in which a transistor element and a diode are connected in anti-parallel. Note that arrangement and connection of the transistor elements or the switching elements in the converter having the boosting function are known, and a description thereof is omitted here.

The capacitor 20 is connected to an output end of the converter 10 via DC buses 22a and 22b. The DC bus 22a is a DC bus on the positive side, and the DC bus 22b is a DC bus on the negative side. The capacitor 20 smooths a rectified voltage applied from the converter 10. Examples of the capacitor 20 include an electrolytic capacitor and a film capacitor.

The inverter 30 is connected to the output end of the converter 10 via the DC buses 22a and 22b, and is connected across the capacitor 20. The inverter 30 converts a DC voltage smoothed by the capacitor 20 into an AC voltage to the compressor 8, and applies the AC voltage to the motor 7 of the compressor 8. The voltage to be applied to the motor 7 is a three-phase AC voltage whose frequency and voltage value are variable.

As illustrated in FIG. 2, the inverter 30 includes an inverter main circuit 310 and a drive circuit 350. The inverter main circuit 310 includes switching elements 311 to 316. Rectifying elements 321 to 326 for reflux are individually connected in anti-parallel to the switching elements 311 to 316.

In the inverter main circuit 310, an insulated gate bipolar transistor (IGBT), a metal oxide semiconductor field effect transistor (MOSFET), or the like is assumed as the switching elements 311 to 316, but any element may be used as long as the element can perform switching. Note that, in a case where the switching elements 311 to 316 are MOSFETs, the MOSFET has a parasitic diode due to its structure. Therefore, a similar effect can be obtained without connecting the rectifying elements 321 to 326 for reflux in anti-parallel.

Further, as a material for forming the switching elements 311 to 316, not only silicon (Si) but also silicon carbide (SiC), gallium nitride (GaN), diamond, and the like which are wide bandgap semiconductors may be used. By forming the switching elements 311 to 316 by using the wide bandgap semiconductor, the loss can be further reduced.

The drive circuit 350 generates drive signals Sr1 to Sr6 on the basis of pulse width modulation (PWM) signals Sm1 to Sm6 output from the control device 100. The drive circuit 350 controls on/off of the switching elements 311 to 316 by using the drive signals Sr1 to Sr6. As a result, the inverter 30 can apply a three-phase AC voltage whose frequency and voltage value are variable, to the motor 7 via output lines 331 to 333.

The PWM signals Sm1 to Sm6 are signals having a signal level of a logic circuit, for example, magnitude of 0 V to 5 V. The PWM signals Sm1 to Sm6 are signals whose reference potential is a ground potential of the control device 100. Whereas, the drive signals Sr1 to Sr6 are signals having a voltage level necessary for controlling the switching elements 311 to 316, for example, magnitude of −15 V to +15 V. The drive signals Sr1 to Sr6 are signals whose reference potential is a potential of a negative terminal of each corresponding switching element, that is, an emitter terminal.

The voltage detecting unit 82 detects a bus voltage Vdc by detecting a voltage across the capacitor 20. The bus voltage Vdc is a voltage between the DC buses 22a and 22b. The voltage detecting unit 82 includes, for example, a voltage dividing circuit that divides a voltage with a resistor connected in series. The voltage detecting unit 82 converts the detected bus voltage Vdc into a voltage suitable for processing in the control device 100, for example, a voltage of 5 V or less by using the voltage dividing circuit, and outputs to the control device 100 as a voltage detection signal which is an analog signal. The voltage detection signal output from the voltage detecting unit 82 to the control device 100 is converted by an analog to digital (AD) converter (not illustrated) in the control device 100 from the analog signal into a digital signal, and is used for internal processing in the control device 100.

The current detecting unit 83 detects a power-supply current Iin, which is a current flowing between the AC power supply 1 and the converter 10. The current detecting unit 83 outputs the detected power-supply current Iin to the control device 100 as a current detection signal which is an analog signal. The current detection signal output from the current detecting unit 83 to the control device 100 is converted by an AD converter (not illustrated) in the control device 100 from the analog signal into a digital signal, and is used for internal processing in the control device 100.

The current detecting unit 84 includes a shunt resistor inserted into the DC bus 22b. The current detecting unit 84 detects a capacitor output current idc by using the shunt resistor. The capacitor output current idc is an input current to the inverter 30, that is, a current output from the capacitor 20 to the inverter 30. The current detecting unit 84 outputs the detected capacitor output current idc to the control device 100 as a current detection signal which is an analog signal. The current detection signal output from the current detecting unit 84 to the control device 100 is converted by an AD converter (not illustrated) in the control device 100 from the analog signal into a digital signal, and is used for internal processing in the control device 100.

The control device 100 generates the PWM signals Sm1 to Sm6 described above, to control an operation of the inverter 30. Specifically, the control device 100 changes an angular frequency we and a voltage value of an output voltage of the inverter 30 on the basis of the PWM signals Sm1 to Sm6.

The angular frequency we of the output voltage of the inverter 30 determines a rotation angular speed at an electrical angle of the motor 7. In this description, this rotation angular speed is also represented by the identical sign we. A rotation angular speed om at a mechanical angle of the motor 7 is equal to a value obtained by dividing the rotation angular speed we at the electrical angle of the motor 7 by a number of pole pairs P. Therefore, there is a relationship expressed by the following Equation (1) between the rotation angular speed om at the mechanical angle of the motor 7 and the angular frequency we of the output voltage of the inverter 30. Note that, in this description, the rotation angular speed may be simply referred to as a “rotation speed”, and the angular frequency may be simply referred to as a “frequency”.

$$\begin{matrix}Formula 1 & \\ ω m = ω e / P & ( 1 )\end{matrix}$$

In a case where an application example of the motor driving device 50 is, for example, an air conditioner, control is performed so as to reduce a rotational speed variation of the motor 7 in order to reduce vibration of the compressor 8. When the rotational speed variation of the motor 7 is reduced, vibration of the compressor 8 is reduced. Therefore, the control for reducing the rotational speed variation is generally called “vibration reduction control”. At this time, the control device 100 controls an operation of the inverter 30 to perform vibration reduction control of reducing vibration of the compressor 8.

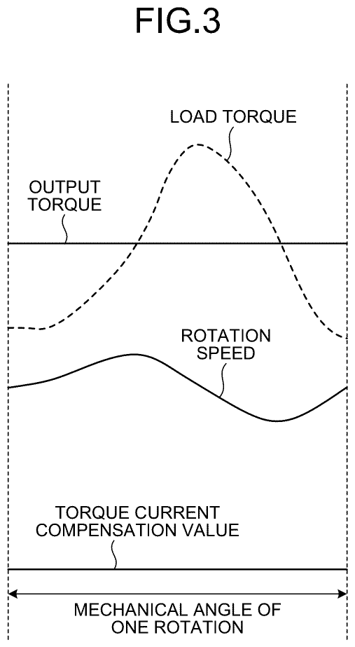

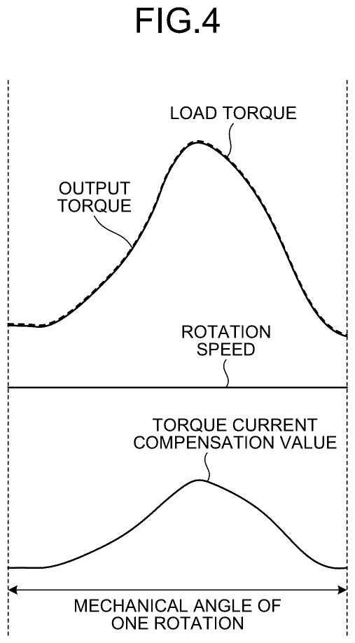

Next, the vibration reduction control in the motor driving device 50 and necessity thereof will be described with reference to FIGS. 3 and 4. FIG. 3 is a diagram illustrating a state of an operation without the vibration reduction control in the motor driving device 50 according to the first embodiment. FIG. 4 is a diagram illustrating a state of an operation with the vibration reduction control in the motor driving device 50 according to the first embodiment.

FIGS. 3 and 4 illustrate a relationship among a load torque of the compressor 8, an output torque of the motor 7, a rotational speed of the motor 7, and a torque current compensation value, in the control device 100 at a mechanical angle of one rotation of the motor 7 in a case where the compressor 8 is a single rotary compressor. FIG. 3 illustrates a state in which the control device 100 controls the output torque of the motor 7 to be constant. Whereas, FIG. 4 illustrates a state in which the control device 100 controls the torque current compensation value so that the output torque of the motor 7 matches with the load torque of the compressor 8, to control the rotational speed to be constant.

As can be seen from FIG. 3, when the control device 100 controls the output torque of the motor 7 to be constant, the rotational speed fluctuates due to a difference between the output torque of the motor 7 and the load torque of the compressor 8. When the rotational speed fluctuates, vibration, noise, and the like are generated in the compressor 8. When the fluctuation of the rotational speed becomes extremely large, there is a possibility that the motor 7 steps out and stops.

Therefore, the control device 100 according to the first embodiment has a function of the vibration reduction control of controlling the output torque of the motor 7 to match with the load torque of the compressor 8. Details of the vibration reduction control will be described later.

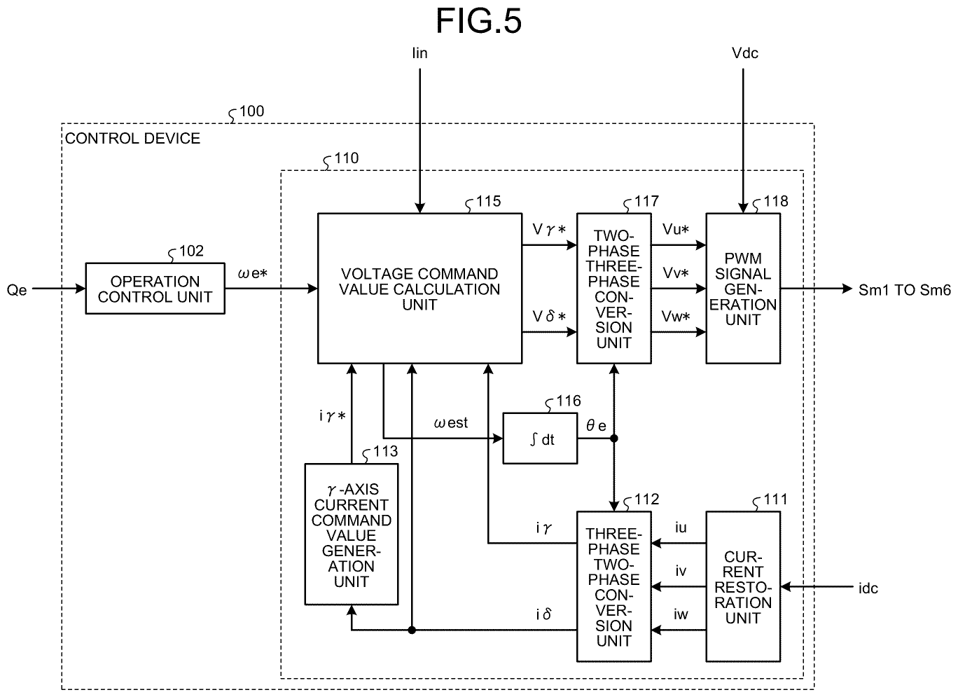

Next, a configuration of the control device 100 will be described with reference to FIG. 5. Note that, in this description, a γδ-axis coordinate system generally used in position sensorless control will be described as a coordinate system of the control unit constructed in the control device 100, but the present disclosure is not limited thereto. For example, when the motor 7 is a permanent magnet motor, a dq-axis coordinate system may be used in which an N-pole of a magnetic pole is a d-axis and an axis orthogonal to the d-axis is a q-axis. At this time, in the processing of the control device 100, as long as the γ-axis is set so that there is no axis error between the γ-axis and the d-axis, the γ-axis and the δ-axis can be handled as the d-axis and the q-axis, respectively. In addition, even when there is an axial error between the γ-axis and the d-axis, the γ-axis and the δ-axis can be regarded as the d-axis and the q-axis, respectively, as long as a control amount is handled in consideration of a difference corresponding to the axial error.

FIG. 5 is a block diagram illustrating a configuration example of the control device 100 included in the power conversion apparatus 2 according to the first embodiment. The control device 100 includes an operation control unit 102 and an inverter control unit 110.

The operation control unit 102 receives command information Qe from the outside, and generates a frequency command value ωe* on the basis of the command information Qe. The frequency command value ωe* can be obtained by multiplying a rotational speed command value ωm*, which is a command value of the rotational speed of the motor 7, by the number of pole pairs P as expressed in the following Equation (2).

$$\begin{matrix}Formula 2 & \\ ω e *= ω m * \text{?} P & ( 2 )\end{matrix}$$

$$\text{?} \text{indicates text missing or illegible when filed}$$

When controlling the air conditioner as the refrigeration cycle application device, the control device 100 controls an operation of each unit of the air conditioner on the basis of the command information Qe. The command information Qe is, for example, a temperature detected by a temperature sensor (not illustrated), information indicating a set temperature instructed from a remote controller which is an operation unit (not illustrated), operation mode selection information, instruction information for operation start and operation end, and the like. The operation mode is, for example, heating, cooling, dehumidification, and the like. Note that, the operation control unit 102 may be external to the control device 100. That is, the control device 100 may be configured to acquire the frequency command value ωe* from the outside.

The inverter control unit 110 includes a current restoration unit 111, a three-phase two-phase conversion unit 112, a γ-axis current command value generation unit 113, a voltage command value calculation unit 115, an electrical phase calculation unit 116, a two-phase three-phase conversion unit 117, and a PWM signal generation unit 118.

The current restoration unit 111 restores phase currents iu, iv, and iw flowing through the motor 7, on the basis of the capacitor output current idc detected by the current detecting unit 84. The current restoration unit 111 can restore the phase currents iu, iv, and iw by sampling a detection value of the capacitor output current idc detected by the current detecting unit 84 at a timing determined on the basis of the PWM signals Sm1 to Sm6 generated by the PWM signal generation unit 118. Note that a current detector may be provided in the output lines 331 to 333 to directly detect the phase currents iu, iv, and iw, and input the phase currents iu, iv, and iw to the three-phase two-phase conversion unit 112. In a case of this configuration, the current restoration unit 111 is unnecessary.

The three-phase two-phase conversion unit 112 converts the phase currents iu, iv, and iw restored by the current restoration unit 111 into a γ-axis current iγ which is an excitation current and a δ-axis current iδ which is a torque current, that is, current values of γ-δ axes, by using an electrical phase θe generated by the electrical phase calculation unit 116 described later.

The γ-axis current command value generation unit 113 generates a γ-axis current command value iγ* which is an excitation current command value, on the basis of the δ-axis current id. More specifically, the γ-axis current command value generation unit 113 obtains a current phase angle at which the output torque of the motor 7 becomes equal to or larger than a set value or becomes a maximum value on the basis of the δ-axis current id, and calculates the γ-axis current command value iγ* on the basis of the obtained current phase angle. Note that, instead of the output torque of the motor 7, a motor current flowing through the motor 7 may be used. In this case, the γ-axis current command value iγ* is calculated on the basis of the current phase angle at which the motor current flowing through the motor 7 becomes equal to or less than the set value or becomes the minimum value. Further, in this description, the γ-axis current command value generation unit may be simply referred to as a “command value generation unit”.

Further, FIG. 5 illustrates a configuration for obtaining the γ-axis current command value iγ* on the basis of the δ-axis current id, but the present disclosure is not limited to this configuration. Instead of the δ-axis current id, the γ-axis current command value iγ* may be obtained on the basis of the γ-axis current iγ. Further, the γ-axis current command value generation unit 113 may determine the γ-axis current command value iγ* by flux weakening control.

The voltage command value calculation unit 115 generates a γ-axis voltage command value Vγ* and a δ-axis voltage command value Vδ*, on the basis of: the frequency command value ωe* acquired from the operation control unit 102; the power-supply current Iin acquired from the current detecting unit 83; the γ-axis current iγ and the δ-axis current id acquired from the three-phase two-phase conversion unit 112; and the γ-axis current command value iγ* acquired from the γ-axis current command value generation unit 113. Further, the voltage command value calculation unit 115 estimates a frequency estimation value ωest on the basis of the γ-axis voltage command value Vγ*, the δ-axis voltage command value Vδ*, the γ-axis current iγ, and the δ-axis current iδ.

The electrical phase calculation unit 116 calculates the electrical phase We by integrating the frequency estimation value ωest acquired from the voltage command value calculation unit 115.

The two-phase three-phase conversion unit 117 converts the γ-axis voltage command value Vγ* and the δ-axis voltage command value Vδ* acquired from the voltage command value calculation unit 115, that is, a voltage command value of the two-phase coordinate system into three-phase voltage command values Vu*, Vv*, and Vw* which are output voltage command values of a three-phase coordinate system, by using the electrical phase θe acquired from the electrical phase calculation unit 116.

The PWM signal generation unit 118 compares the three-phase voltage command values Vu*, Vv*, and Vw* acquired from the two-phase three-phase conversion unit 117 with the bus voltage Vdc detected by the voltage detecting unit 82, to generate the PWM signals Sm1 to Sm6. Note that, the PWM signal generation unit 118 may stop the motor 7 by not outputting the PWM signals Sm1 to Sm6.

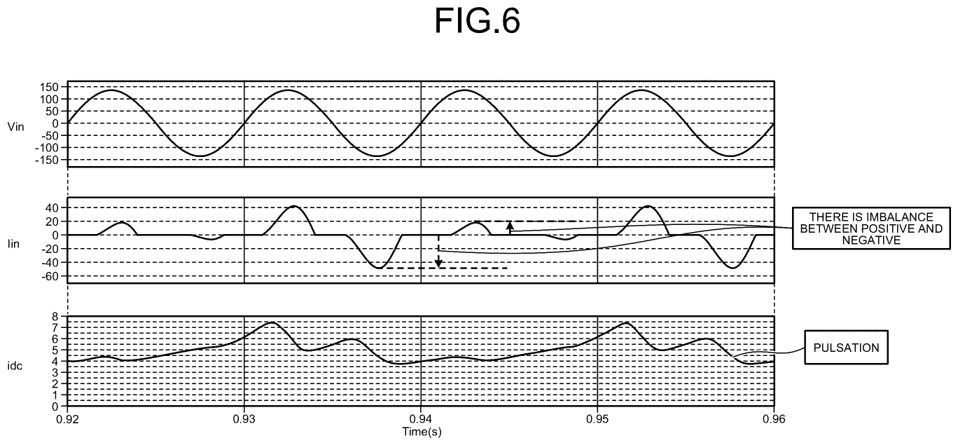

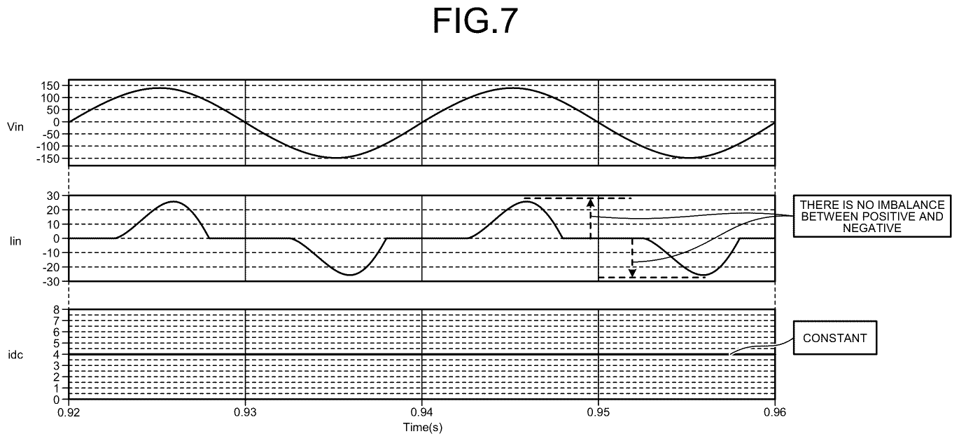

Next, a reason why the object of the present application occurs will be described. FIGS. 6 and 7 are first and second views for explaining the object of the present application, respectively. The object of the present application has been briefly described in the section of [Problem to be solved by the Invention], but a more detailed description will be added here.

First, when the load is a load having torque pulsation, such as a single rotary compressor, a scroll compressor, or a twin rotary compressor, the above-described vibration reduction control is performed. In general vibration reduction control, the inverter 30 is controlled by generating a torque current compensation value so that the output torque of the motor 7 follows the torque pulsation of the compressor 8. However, when this control is simply performed, as described in the section of [Problem to be solved by the Invention], a problem occurs in which the power-supply current Iin is brought into an imbalance state between positive and negative polarities, and a harmonic component of the power-supply current Iin increases.

FIGS. 6 and 7 illustrate waveforms of a power-supply voltage Vin, the power-supply current Iin, and the capacitor output current idc in order from an upper stage. A horizontal axis in FIGS. 6 and 7 represents time.

A middle stage of FIG. 6 illustrates a state in which a peak value of a waveform on the positive side and a peak value of a waveform on the negative side in the power-supply current Iin are different, that is, a state in which the peak value is imbalance between the positive and negative polarities of the power-supply current Iin. When such an imbalance occurs, as illustrated in a lower stage, pulsation occurs in the capacitor output current idc. As a result, the power-supply current Iin includes a lot of harmonic component.

Note that, it has been found by the inventors of the present application that the pulsation of the capacitor output current idc increases as the load torque increases and inertia of the load decreases, and remarkably appears when the load torque is large during the vibration reduction control. In addition, it has been found by the inventors of the present application that the pulsation of the capacitor output current idc is larger in a single rotary compressor than that in a twin rotary compressor and a scroll compressor.

Further, the lower stage of FIG. 7 illustrates an ideal state in which the capacitor output current idc is constant. In such an ideal state, as illustrated in the middle stage of FIG. 7, a peak value of a waveform on the positive side and a peak value of a waveform on the negative side in the power-supply current Iin are equal, and the imbalance between positive and negative in the power-supply current Iin does not occur. Therefore, the harmonic component that can be included in the power-supply current Iin is much smaller than that in the case of FIG. 6.

As described above, the harmonic component that can be included in the power-supply current Iin is related to the pulsation of the capacitor output current idc. Therefore, the voltage command value calculation unit 115 included in the control device 100 according to the first embodiment performs control to reduce a harmonic component that can be included in the power-supply current Iin when the vibration reduction control is performed.

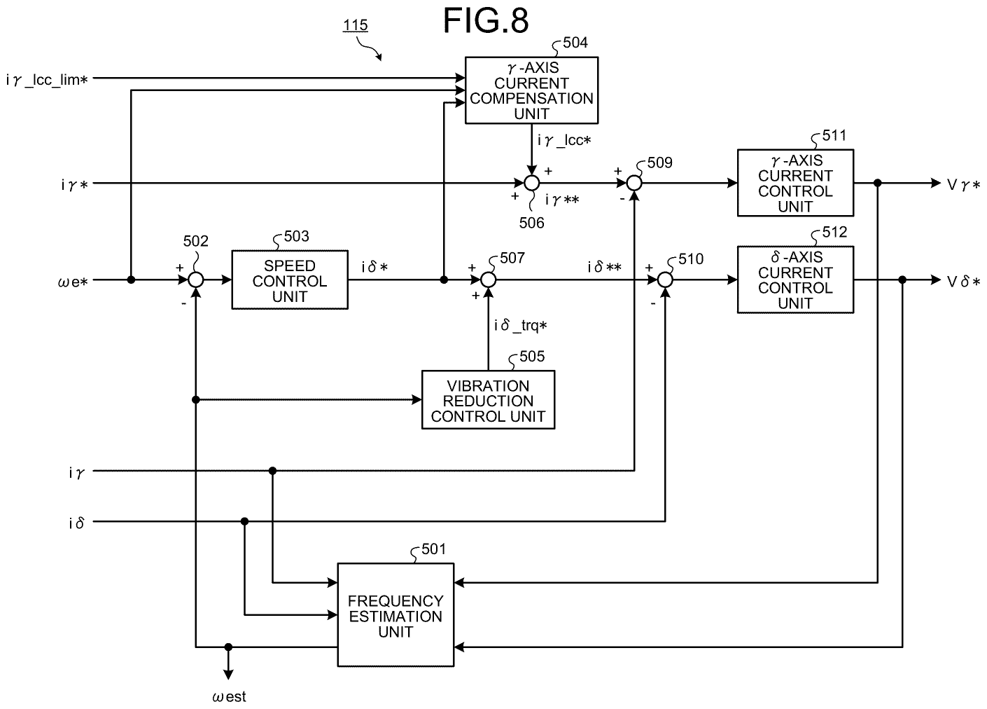

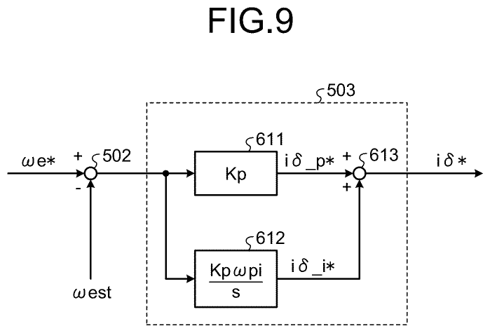

FIG. 8 is a block diagram illustrating a configuration example of the voltage command value calculation unit 115 included in the control device 100 according to the first embodiment. As illustrated in FIG. 8, the voltage command value calculation unit 115 includes a frequency estimation unit 501, subtraction units 502, 509, and 510, a speed control unit 503, a γ-axis current compensation unit 504, a vibration reduction control unit 505, addition units 506 and 507, a γ-axis current control unit 511, and a δ-axis current control unit 512. Further, FIG. 9 is a block diagram illustrating a configuration example of the speed control unit 503 included in the voltage command value calculation unit 115 according to the first embodiment. Note that, FIG. 9 also illustrates the subtraction unit 502 positioned at a preceding stage of the speed control unit 503.

The frequency estimation unit 501 estimates a frequency of a voltage to be applied to the motor 7 on the basis of the γ-axis current iγ, the δ-axis current id, the γ-axis voltage command value Vγ*, and the δ-axis voltage command value Vδ*, and outputs the estimated frequency as the frequency estimation value ωest.

The subtraction unit 502 calculates a difference (ωe*-ωest) between the frequency command value ωe* and the frequency estimation value ωest estimated by the frequency estimation unit 501.

The speed control unit 503 generates a δ-axis current command value iδ* which is a torque current command value in a rotating coordinate system. More specifically, the speed control unit 503 performs proportional integral calculation, that is, proportional integral (PI) control on the difference (ωe*-ωest) calculated by the subtraction unit 502, to calculate the δ-axis current command value iδ* that brings the difference (ωe*-ωest) close to 0.

FIG. 9 illustrates a configuration example of the speed control unit 503. As illustrated in FIG. 9, the speed control unit 503 is a control unit that generates a current command value on the basis of a frequency deviation. The speed control unit 503 includes a proportional control unit 611, an integration control unit 612, and an addition unit 613.

In the speed control unit 503, the proportional control unit 611 performs proportional control on the difference (ωe*-ωest), which is acquired from the subtraction unit 502, between the frequency command value ωe* and the frequency estimation value ωest, and outputs a proportional term iδ_p*. The integration control unit 612 performs integral control on the difference (ωe*-ωest), which is acquired from the subtraction unit 502, between the frequency command value ωe* and the frequency estimation value ωest, and outputs an integral term iδ_i*. The addition unit 613 adds the proportional term iδ_p* acquired from the proportional control unit 611 and the integral term iδ_i* acquired from the integration control unit 612, to generate the δ-axis current command value iδ*.

As described above, the speed control unit 503 generates and outputs the δ-axis current command value iδ* that causes the frequency estimation value ωest to match with the frequency command value ωe*.

Returning to FIG. 8, the vibration reduction control unit 505 generates a δ-axis current compensation value iδ_trq*, which is a compensation value of the δ-axis current command value iδ* in the vibration reduction control, on the basis of the frequency estimation value ωest acquired from the frequency estimation unit 501. Specifically, the vibration reduction control unit 505 generates the δ-axis current compensation value iδ_trq* such that the output torque of the motor 7 follows a periodic variation of the load torque of the compressor 8.

The δ-axis current compensation value iδ_trq* is a component of a control amount for reducing a pulsation component of the frequency estimation value ωest, particularly, a pulsation component whose frequency is ωmn. Here, the “a pulsation component of the frequency estimation value ωest, particularly a pulsation component whose frequency is ωmn” means a pulsation component of a straight flow rate (or a DC amount) which is a value representing the frequency estimation value ωest, particularly, a pulsation component whose pulsation frequency is ωmn. Note that reference character “m” indicates a parameter related to a DC amount, and reference character “n” indicates a parameter indicating the compressor 8 that is a load driven by the motor 7. For example, the value of “n” is 1 when the compressor 8 is a single rotary compressor, and is 2 when the compressor 8 is a twin rotary compressor. This value of “n” may be 3 or more. Note that, in this description, the δ-axis current compensation value may be referred to as a “torque current compensation value”.

The γ-axis current compensation unit 504 generates a γ-axis current compensation value iγ_lcc* on the basis of the frequency command value ωe*, the δ-axis current command value i* output from the speed control unit 503, and a γ-axis current limit value iγ_lcc_lim*. The γ-axis current compensation value iγ_lcc* is a component of a control amount for reducing pulsation of the capacitor output current idc. Further, the γ-axis current limit value iγ_lcc_lim* is a component of a control amount for limiting the γ-axis current compensation value iγ_lcc*. Details of the γ-axis current compensation value iγ_lcc* and the γ-axis current limit value iγ_lcc_lim* will be described later. Note that, in this description, the γ-axis current compensation value may be referred to as an “excitation current compensation value”. Further, in this description, the γ-axis current compensation unit may be referred to as an “excitation current compensation unit”, and the control by the γ-axis current compensation unit 504 may be referred to as “γ-axis current compensation control” or “excitation current compensation control”. Further, in this description, the control for limiting the γ-axis current compensation value iγ_lcc* by using the γ-axis current limit value iγ_lcc_lim* may be referred to as “γ-axis current compensation limiting control” or “excitation current compensation limiting control”.

The addition unit 506 generates a γ-axis current command value iγ** by adding the γ-axis current command value iγ* and the γ-axis current compensation value iγ_lcc* acquired from the γ-axis current compensation unit 504, that is, superimposing the γ-axis current compensation value iγ_lcc* on the γ-axis current command value iγ*. The generated γ-axis current command value iγ** is input to the subtraction unit 509.

The addition unit 507 generates the δ-axis current command value iδ**, by adding the δ-axis current command value id* and the δ-axis current compensation value iδ_trq* acquired from the vibration reduction control unit 505, that is, superimposing the δ-axis current compensation value iδ_trq* on the δ-axis current command value iδ*. The generated δ-axis current command value iδ** is input to the subtraction unit 510.

The subtraction unit 509 calculates a difference (iγ**−iγ) between the γ-axis current command value iγ** and the γ-axis current iγ. The subtraction unit 510 calculates a difference (iδ**−iδ) between the δ-axis current command value iδ** and the δ-axis current iδ.

The γ-axis current control unit 511 performs proportional integral calculation on the difference (iγ**−iγ) calculated by the subtraction unit 509, to generate the γ-axis voltage command value Vγ* that brings the difference (iγ**−iγ) close to 0. By generating the γ-axis voltage command value Vγ*, the γ-axis current control unit 511 performs control to cause the γ-axis current iγ to match with the γ-axis current command value iγ**.

The δ-axis current control unit 512 performs proportional integral calculation on the difference (iδ**−iδ) calculated by the subtraction unit 510, to generate the δ-axis voltage command value Vδ* that brings the difference (iδ**-18) close to 0. By generating the δ-axis voltage command value Vδ*, the δ-axis current control unit 512 performs control to cause the δ-axis current id to match with the δ-axis current command value iδ**.

In the control described above, the γ-axis current command value iγ** output from the subtraction unit 509 and input to the γ-axis current control unit 511 includes the γ-axis current compensation value iγ_lcc* acquired from the γ-axis current compensation unit 504. Therefore, when the γ-axis current control unit 511 controls the inverter 30 on the basis of the γ-axis voltage command value VY* generated on the basis of the γ-axis current compensation value iγ_lcc*, the pulsation of the capacitor output current idc can be reduced.

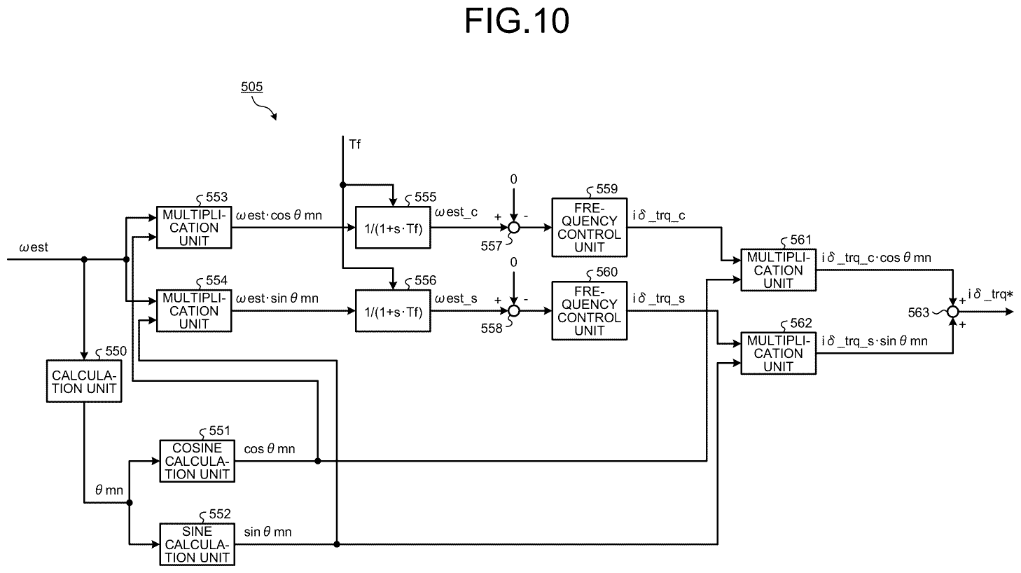

Next, a configuration of the vibration reduction control unit 505 will be described. FIG. 10 is a block diagram illustrating a configuration example of the vibration reduction control unit 505 included in the voltage command value calculation unit 115 according to the first embodiment. The vibration reduction control unit 505 includes a calculation unit 550, a cosine calculation unit 551, a sine calculation unit 552, multiplication units 553 and 554, low-pass filters 555 and 556, subtraction units 557 and 558, frequency control units 559 and 560, multiplication units 561 and 562, and an addition unit 563.

The calculation unit 550 calculates a mechanical angle phase θmn indicating a rotational position of the motor 7, by integrating the frequency estimation value ωest and dividing the integration result by a number of pole pairs P. The cosine calculation unit 551 calculates a cosine value cos θmn on the basis of the mechanical angle phase θmn. The sine calculation unit 552 calculates a sine value sin θmn on the basis of the mechanical angle phase θmn.

The multiplication unit 553 multiplies the frequency estimation value ωest by the cosine value cos θmn, to calculate a cosine component ωest·cos θmn of the frequency estimation value ωest. The multiplication unit 554 multiplies the frequency estimation value ωest by the sine value sin θmn, to calculate a sine component ωest·sin θmn of the frequency estimation value ωest. The cosine component ωest·cos θmn and the sine component ωest·sin θmn calculated by the multiplication units 553 and 554 include a pulsation component having a frequency higher than ωmn, that is, a harmonic component, in addition to a pulsation component having the frequency of ωmn.

The low-pass filters 555 and 556 are first-order lag filters whose transfer function is represented by 1/(1+s·Tf). Here, reference character “s” indicates a Laplace operator. Reference character “Tf” indicates a time constant, and is determined so as to remove a pulsation component having a frequency higher than the frequency ωmn. Note that “remove” includes a case where a part of the pulsation component is attenuated, that is, reduced. The time constant Tf is set by the operation control unit 102 on the basis of a speed command value, and the operation control unit 102 may notify the low-pass filters 555 and 556 of the time constant Tf, or the time constant Tf may be held by the low-pass filters 555 and 556. Regarding the low-pass filters 555 and 556, the first-order lag filter is an example, and may be a moving average filter or the like, and a type of filter is not limited as long as the pulsation component on a high-frequency side can be removed.

The low-pass filter 555 performs low-pass filtering on the cosine component ωest·cos θmn to remove a pulsation component having a frequency higher than the frequency ωmn, and outputs a low-frequency component ωest_c. The low-frequency component ωest_c is a DC amount representing a cosine component having the frequency of ωmn among pulsation components of the frequency estimation value ωest.

The low-pass filter 556 performs low-pass filtering on the sine component ωest·sin θmn, removes a pulsation component having a frequency higher than the frequency ωmn, and outputs a low-frequency component ωest_s. The low-frequency component ωest_s is a DC amount representing a sine component having the frequency of ωmn among the pulsation components of the frequency estimation value ωest.

The subtraction unit 557 calculates a difference (ωest_c−0) between 0 and the low-frequency component ωest_c output from the low-pass filter 555. The subtraction unit 558 calculates a difference (ωest_s−0) between 0 and the low-frequency component ωest_s output from the low-pass filter 556.

The frequency control unit 559 performs proportional integral calculation on the difference (ωest_c−0) calculated by the subtraction unit 557, to calculate a cosine component iδ_trq_c of the current command value that brings the difference (ωest_c−0) close to 0. By generating the cosine component iδ_trq_c in this manner, the frequency control unit 559 performs control for causing the low-frequency component ωest_c to match with 0.

The frequency control unit 560 performs proportional integral calculation on the difference (ωest_s−0) calculated by the subtraction unit 558, to calculate a sine component iδ_trq_s of the current command value that brings the difference (ωest_s−0) close to 0. By generating the sine component iδ_trq_s in this manner, the frequency control unit 560 performs control for causing the low-frequency component ωest_s to match with 0.

The multiplication unit 561 multiplies the cosine component iδ_trq_c output from the frequency control unit 559 by the cosine value cos θmn, to generate iδ_trq_c·cos θmn. iδ_trq_c·cos θmn is an AC component having a frequency n·ωest.

The multiplication unit 562 multiplies the sine component iδ_trq_s output from the frequency control unit 560 by the sine value sin θmn, to generate iδ_trq_s·sin θmn. iδ_trq_s·sin θmn is an AC component having the frequency n·ωest.

The addition unit 563 obtains a sum of iδ_trq_c·cos θmn output from the multiplication unit 561 and iδ_trq_s·sin θmn output from the multiplication unit 562. The vibration reduction control unit 505 outputs a value obtained by the addition unit 563, as the δ-axis current compensation value iδ_trq*.

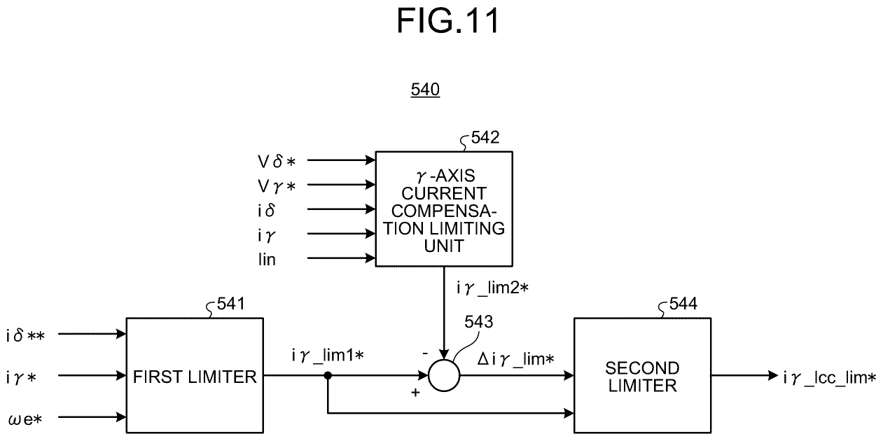

Next, the above-described γ-axis current limit value iγ_lcc_lim* will be described. FIG. 11 is a block diagram illustrating a configuration example of the γ-axis current limit value generation unit 540 that generates the γ-axis current limit value iγ_lcc_lim*, which is an input signal to the γ-axis current compensation unit 504 according to the first embodiment. As illustrated in FIG. 11, the γ-axis current limit value generation unit 540 includes a first limiter 541, a γ-axis current compensation limiting unit 542, a subtraction unit 543, and a second limiter 544.

The first limiter 541 generates a first γ-axis current limit value iγ_lim1* on the basis of the γ-axis current command value iγ* input to the addition unit 506, the δ-axis current command value iδ** output from the addition unit 507, and the frequency command value ωe* acquired from the operation control unit 102. The first γ-axis current limit value iγ_lim1* can be calculated by the following technique and procedure.

First, motor power which is active power supplied from the inverter 30 to the motor 7 is represented by Pm. The motor power Pm can be expressed by the following Equation (3).

$$\begin{matrix}Formula 3 & \\ & ( 3 )\end{matrix}$$

$$Pm = V γ \cdot i γ + V δ \cdot i δ = ( Ra \cdot i γ - ω e \cdot L δ \cdot i δ ) i γ + ( Ra \cdot i δ + ω e ( L γ \cdot i γ + φ a ) i δ = Ra \cdot i {γ}^{2} - ω e \cdot L δ \cdot i δ \cdot i γ + Ra \cdot i {δ}^{2} + ω e ( L γ \cdot i γ + φ a ) i δ = Ra ( i {γ}^{2} + i {δ}^{2} ) + ω e \cdot i δ ( φ a + ( L γ - L δ ) i γ )$$

Meanings of symbols shown in Equation (3) above are as follows.
Vγ: a γ-axis voltage in the motor 7
Vδ: a δ-axis voltage in the motor 7
iγ: a γ-axis current flowing through the motor 7
iδ: a δ-axis current flowing through the motor 7
Ra: a phase resistance in the motor 7
ωe: a frequency (electrical angle) of an output voltage of the inverter 30
Lγ: a γ-axis inductance in the motor 7
Lδ: a δ-axis inductance in the motor 7
φa: an induced voltage constant in the motor 7

Furthermore, when the power supplied from the capacitor 20 to the inverter 30 is represented by Pdc, Pm≈Pdc can be considered. Therefore, from Equation (3) above, the capacitor output current idc can be expressed by the following Equation (4).

$$\begin{matrix}Formula 4 & \\ idc = Pdc / Vdc \approx Pm / Vdc = Ra ( i {γ}^{2} + i {δ}^{2} ) / Vdc + ω e \cdot i δ ( φ a + ( L γ - L δ ) i γ ) / Vdc & ( 4 )\end{matrix}$$

The first term on the right side of Equation (4) above is a term representing a copper loss of the motor 7, and the second term on the right side of Equation (4) above is a term representing a mechanical output of the motor 7 (hereinafter referred to as a “motor mechanical output”). That is, it can be seen that the capacitor output current idc is affected by the copper loss of the motor 7 and the motor mechanical output.

The first limiter 541 calculates two candidate values as candidates for the first γ-axis current limit value iγ_lim1*, specifically, a first candidate value iγ_lim1 and a second candidate value iγ_lim2. Among these candidate values, the first candidate value iγ_lim1 is calculated using, for example, the following Equation (5).

$$\begin{matrix}Formula 5 & \\ i γ\_lim1 = \sqrt{3 \text{?} {e}^{2} - i δ {**}^{2}} - \vert i γ * \vert & ( 5 )\end{matrix}$$

$$\text{?} \text{indicates text missing or illegible when filed}$$

In Equation (5) above, reference character “Ie” represents an effective value of limit values of the phase currents iu, iv, and iw determined from an overcurrent cutoff protection threshold value in the inverter 30, and is generally set to be lower than the overcurrent cutoff protection threshold value by about 10% to 20%. As shown in Equation (5) above, the first candidate value iγ_lim1 can be obtained by subtracting a square value of the δ-axis current command value iδ** from a value obtained by multiplying a square value of the effective value Ie by 3 to obtain a square root thereof, and further subtracting an absolute value of the γ-axis current command value iγ* from the square root.

Equation (5) above can be used as it is in a low speed range of the motor 7, but needs to be corrected in a high speed range of the motor 7. This is because the d-axis current, that can be caused to flow, decreases due to an influence of voltage saturation in the high speed range. It is known that, when the δ-axis current command value iδ** becomes excessive, control may become unstable due to a wind-up phenomenon of the integrator. In Equation (5) above, a decrease in a maximum δ-axis current accompanying an increase in speed is not considered. Therefore, here, a formula is derived in consideration of a decrease in the maximum d-axis current.

First, in the high-speed region, when a limit value of the γδ-axis voltage is Vom, a relationship of the following Equation (6) is established for the limit value Vom.

$$\begin{matrix}Formula 6 & \\ {( φ a + L γ \cdot i γ )}^{2} + {( L δ \cdot i δ )}^{2} = {( \frac{Vom}{ω e \cdot L δ} )}^{2} & ( 6 )\end{matrix}$$

The limit value Vom in Equation (6) above represents a radius of the voltage limit circle on a γδ plane, and there is a relationship of (Vγ**)²+(Vδ**)²−Vom² among the δ-axis current command value iδ**, the γ-axis current command value iγ**, and the limit value Vom. Equation (6) above is obtained by substituting corresponding elements in a voltage equation in a steady state into this equation, and organizing while ignoring a voltage drop due to armature resistance. By solving Equation (6) for the γ-axis current iγ, the following Equation (7) is obtained.

$$\begin{matrix}Formula 7 & \\ i γ = \frac{- φ a \pm \sqrt{{( \frac{Vom}{ω e} )}^{2} - {( L δ \cdot i δ )}^{2}}}{L γ} & ( 7 )\end{matrix}$$

Equation (7) above is used to calculate the second candidate value iγ_lim2. Therefore, the second candidate value iγ_lim2 of when the δ-axis current id is caused to flow up to the δ-axis current command value iδ** can be calculated using the following Equation (8) obtained by substituting the δ-axis current command value iδ** into Equation (7) above.

$$\begin{matrix}Formula 8 & \\ i γ\_lim2 = \frac{- φ a \pm \sqrt{{{( \frac{Vom}{ω e} )}^{2} - ( L δ \cdot i δ \text{**)}}^{2}}}{L γ} & ( 8 )\end{matrix}$$

As described above, the first γ-axis current limit value iγ_lim1* is determined by the following Equation (9) in consideration of both the above Equations (5) and (8).

$$\begin{matrix}Formula 9 & \\ i γ\_lim1 *= MIN ( i γ\_lim1 , i γ\_lim2 ) & ( 9 )\end{matrix}$$

In Equation (9) above, reference character “MIN” indicates a function for selecting a minimum one.

As described above, the first limiter 541 calculates Equations (5) and (8) described above, and outputs a smaller one of the calculation values to the subtraction unit 543 and the second limiter 544 as the first γ-axis current limit value iγ_lim1*.

Next, the γ-axis current compensation limiting unit 542 will be described. The γ-axis current compensation limiting unit 542 is a control unit that generates a control amount for limiting the γ-axis current compensation value iγ_lcc* generated by the γ-axis current compensation unit 504 so as to reduce a harmonic component included in the power-supply current Iin flowing between the AC power supply 1 and the converter 10. The γ-axis current compensation limiting unit 542 generates a second γ-axis current limit value iγ_lim2* on the basis of the γ-axis current iγ, the δ-axis current id, the γ-axis voltage command value Vγ*, the δ-axis voltage command value Vδ*, and the power-supply current Iin. Note that, in this description, the second γ-axis current limit value iγ_lim2* may be referred to as an “excitation current limit value” or simply as a “limit value”.

The γ-axis current compensation limiting unit 542 outputs the generated second γ-axis current limit value iγ_lim2* to the subtraction unit 543. Note that, details of the second γ-axis current limit value iγ_lim2* and a configuration of the γ-axis current compensation limiting unit 542 for generating the second γ-axis current limit value iγ_lim2* will be described later.

The subtraction unit 543 calculates Δiγ_lim*=iγ_lim1*−iγ_lim2*, which is a difference value between the first γ-axis current limit value iγ_lim1* and the second γ-axis current limit value iγ_lim2*, and outputs the result to the second limiter 544. The second limiter 544 generates the γ-axis current limit value iγ_lcc_lim*, on the basis of the difference value Δiγ_lim* and the first γ-axis current limit value iγ_lim1*. As described above, the γ-axis current limit value iγ_lcc_lim* is an input signal to the γ-axis current compensation unit 504.

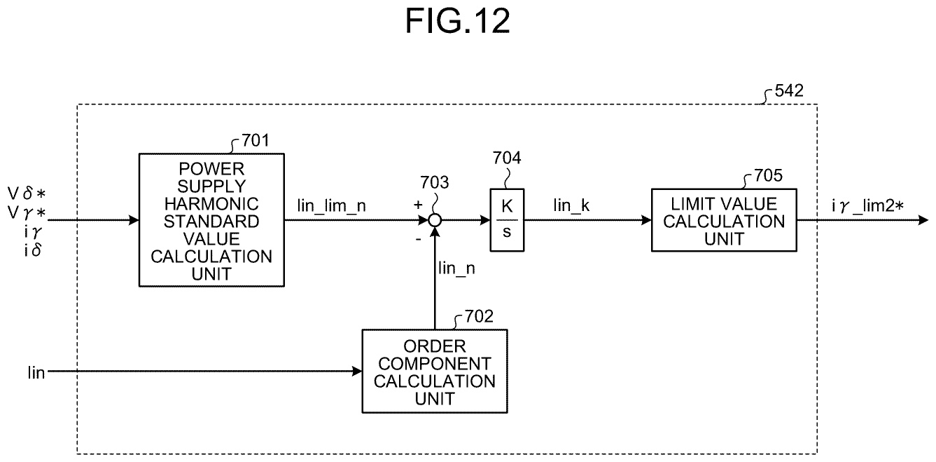

Next, a configuration of the γ-axis current compensation limiting unit 542 will be described. FIG. 12 is a block diagram illustrating a first configuration example of the γ-axis current compensation limiting unit 542 according to the first embodiment. The γ-axis current compensation limiting unit 542 includes a power supply harmonic standard value calculation unit 701, an order component calculation unit 702, a subtraction unit 703, an integration unit 704, and a limit value calculation unit 705.

The power supply harmonic standard value calculation unit 701 calculates a power supply harmonic standard value Iin_lim_n, on the basis of the γ-axis current iγ, the δ-axis current id, the γ-axis voltage command value Vγ*, and the 8-axis voltage command value Vδ*. The power supply harmonic standard value Iin_lim_n is a threshold value for determining whether a certain frequency component satisfies a power supply harmonic standard.

The order component calculation unit 702 calculates an order component Iin_n, which is a harmonic component of a specific order included in the power-supply current Iin, on the basis of the power-supply current Iin acquired from the current detecting unit 83. The order component Iin_n calculated by the order component calculation unit 702 is used for comparison with the power supply harmonic standard value Iin_lim_n calculated by the power supply harmonic standard value calculation unit 701, and the order of each harmonic component is identical.

The subtraction unit 703 calculates a difference (Iin_lim_n-Iin_n) between the power supply harmonic standard value Iin_lim_n output from the power supply harmonic standard value calculation unit 701 and the order component Iin_n output from order component calculation unit 702.

The integration unit 704 is an arithmetic unit in which a transfer function is represented by K/s. Reference character “s” indicates a Laplace operator, and reference character “K” indicates a multiplication coefficient. The integration unit 704 performs an integration operation on a difference (Iin_lim_n-Iin_n) output from the subtraction unit 703. Note that the integral operation here is an example, and proportional integral calculation may be performed instead of the integral operation. An integral value Iin_k, which is an output of the integration unit 704, is input to the limit value calculation unit 705.

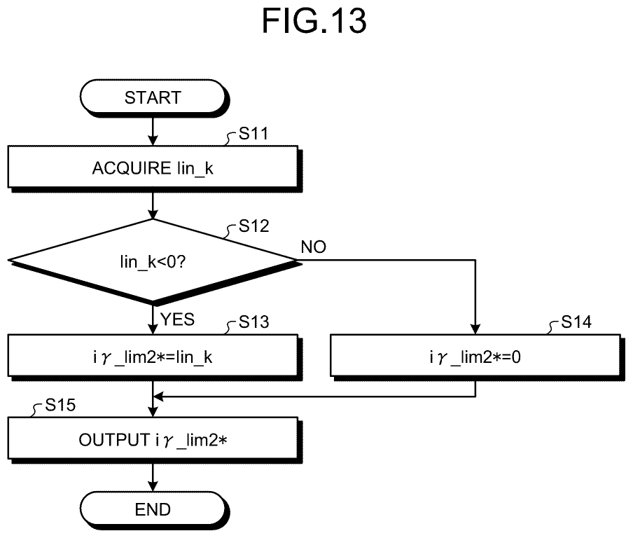

FIG. 13 is a flowchart for explaining an operation of the limit value calculation unit 705 included in the γ-axis current compensation limiting unit 542 according to the first embodiment. The limit value calculation unit 705 acquires the integral value Iin_k from the integration unit 704 (step S11). The limit value calculation unit 705 compares the integral value Iin_k with 0 (step S12). When the integral value Iin_k is less than 0 (step S12, Yes), the limit value calculation unit 705 sets the second γ-axis current limit value iγ_lim2* as the integral value Iin_k (step S13), and outputs the calculated second γ-axis current limit value iγ_lim2* (step S15). When the integral value Iin_k is 0 or more (step S12, No), the limit value calculation unit 705 sets the second γ-axis current limit value iγ_lim2* to 0 (step S14), and outputs the set second γ-axis current limit value iγ_lim2* (step S15).

Through the processing described above, the γ-axis current compensation limiting unit 542 calculates the power supply harmonic standard value Iin_lim_n and the order component Iin_n, and calculates the second γ-axis current limit value iγ_lim2* for an amount by which the order component Iin_n exceeds the power supply harmonic standard value Iin_lim_n. In the processing of the γ-axis current compensation unit 504 to be described later, the γ-axis current compensation control is performed such that the γ-axis current compensation value iγ_lcc*, which is a compensation value of the γ-axis current compensation control, is limited by the second γ-axis current limit value iγ_lim2* calculated here. As a result, the γ-axis current compensation control is to be performed such that the specific order component Iin_n in the power-supply current Iin conforms to the power supply harmonic standard.

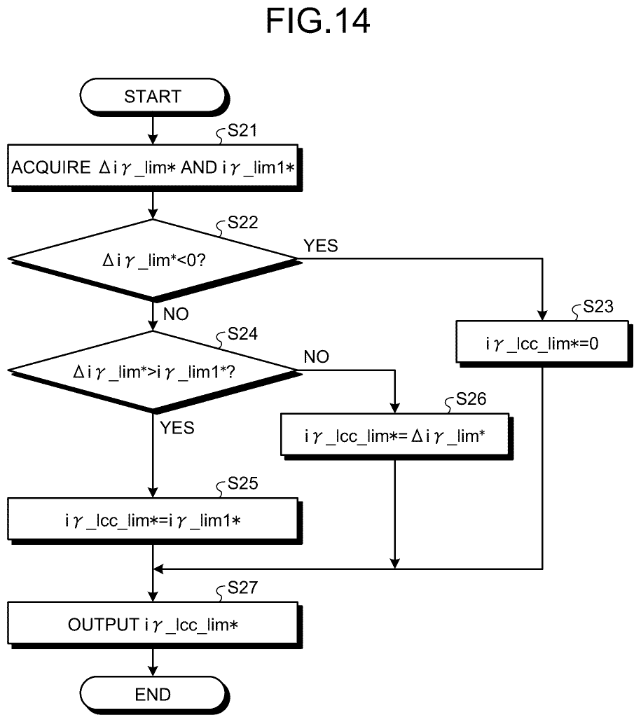

FIG. 14 is a flowchart for explaining an operation of the second limiter 544 included in the γ-axis current limit value generation unit 540 according to the first embodiment. The second limiter 544 acquires the first γ-axis current limit value iγ_lim1* from the first limiter 541, and acquires the difference value Δiγ_lim* from the subtraction unit 543 (step S21). The second limiter 544 compares the difference value Δiγ_lim* with 0 (step S22). When the difference value Δiγ_lim* is less than 0 (step S22, Yes), the second limiter 544 sets the γ-axis current limit value iγ_lcc_lim* to 0 (step S23), and outputs the set γ-axis current limit value iγ_lcc_lim* (step S27). When the difference value Δiγ_lim* is 0 or more (step S22, No), the second limiter 544 compares the difference value Δiγ_lim* with the first γ-axis current limit value iγ_lim1* (step S24). When the difference value Δiγ_lim* is larger than the first γ-axis current limit value iγ_lim1* (step S24, Yes), the second limiter 544 sets the γ-axis current limit value iγ_lcc_lim* to the first γ-axis current limit value iγ_lim1* (step S25), and outputs the set γ-axis current limit value iγ_lcc_lim* (step S27). When the difference value Δiγ_lim* is equal to or less than the first γ-axis current limit value iγ_lim1* (step S24, No), the second limiter 544 sets the γ-axis current limit value iγ_lcc_lim* to the difference value Δiγ_lim* (step S26), and outputs the set γ-axis current limit value iγ_lcc_lim* (step S27).

Through the processing described above, the γ-axis current limit value iγ_lcc_lim* generated by the γ-axis current limit value generation unit 540 is output to the γ-axis current compensation unit 504, with a maximum value limited to the first γ-axis current limit value iγ_lim1* and a minimum value limited to 0.

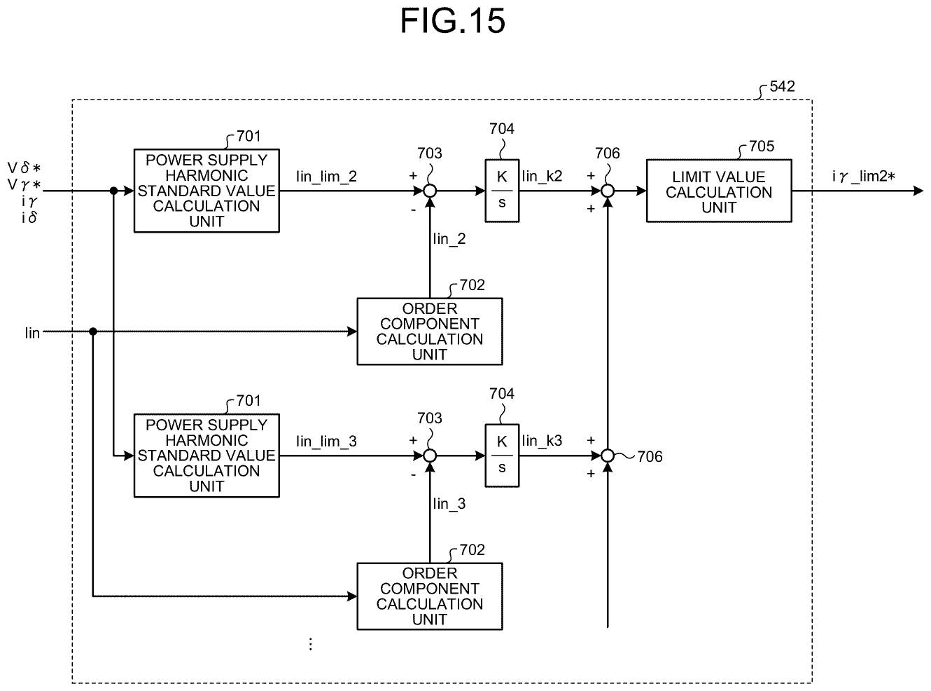

Note that FIG. 12 illustrates a configuration example of the γ-axis current compensation limiting unit 542 in a case where the number of harmonic components to be reduced is 1. However, the configuration can be similarly applied to a case where the number of harmonic components to be reduced is 2 or more. FIG. 15 is a block diagram illustrating a second configuration example of the γ-axis current compensation limiting unit 542 according to the first embodiment. In FIG. 15, components identical or equivalent to those in FIG. 12 are denoted by identical reference numerals.

In FIG. 15, the power supply harmonic standard value calculation unit 701 of the first stage calculates a power supply harmonic standard value Iin_lim_2 on the basis of the γ-axis current iγ, the δ-axis current id, the γ-axis voltage command value Vγ*, and the δ-axis voltage command value Vδ*. The power supply harmonic standard value Iin_lim_2 is a power supply harmonic standard value in which the order of harmonics is “2”, that is, the second order. Similarly, the power supply harmonic standard value calculation unit 701 of the second stage calculates a power supply harmonic standard value Iin_lim_3 on the basis of the γ-axis current iγ, the δ-axis current iδ, the γ-axis voltage command value Vγ*, and the δ-axis voltage command value Vδ*. The power supply harmonic standard value Iin_lim_3 is a power supply harmonic standard value in which the order of harmonics is “3”, that is, the third order.

Further, the order component calculation unit 702 of the first stage calculates an order component Iin_2 on the basis of the power-supply current Iin. The order component Iin_2 is a second-order harmonic component included in the power-supply current Iin. Similarly, the order component calculation unit 702 of the second stage calculates an order component Iin_3 on the basis of the power-supply current Iin. The order component Iin_3 is a third-order harmonic component included in the power-supply current Iin.

The subtraction unit 703 of the first stage calculates a difference (Iin_lim_2-Iin_2) between the power supply harmonic standard value Iin_lim_2 and the order component Iin_2. The difference (Iin_lim_2-Iin_2) is subjected to integration processing by the corresponding integration unit 704, and an integral value Iin_k2 is output.

The subtraction unit 703 of the second stage calculates a difference (Iin_lim_3-Iin_3) between the power supply harmonic standard value Iin_lim_3 and the order component Iin_3. The difference (Iin_lim_3-Iin_3) is subjected to integration processing by the corresponding integration unit 704, and an integral value Iin_k3 is output. These integral values Iin_k2 and Iin_k3 are added by an addition unit 706, and output to the limit value calculation unit 705. The limit value calculation unit 705 performs processing according to the flowchart of FIG. 13, and generates and outputs the second γ-axis current limit value iγ_lim2* described above.

Note that, FIG. 15 illustrates a case where the number of harmonic components to be reduced is two (the second order and the third order). When the number of harmonic components to be reduced is three or more, the number of processing stages may simply be sequentially increased, and addition may be performed by the addition unit 706.

Furthermore, the number of the addition units 706 is not necessarily equal to the number of stages, and any configuration may be used as long as the output of each integration unit 704 is added and input to the limit value calculation unit 705. Further, the configurations of FIGS. 12 and 15 are examples, and the present disclosure is not limited to these examples. Any control system may be used as long as the control system operates so that a compensation value of the vibration reduction control is limited, and the control system may be implemented by using any configuration.

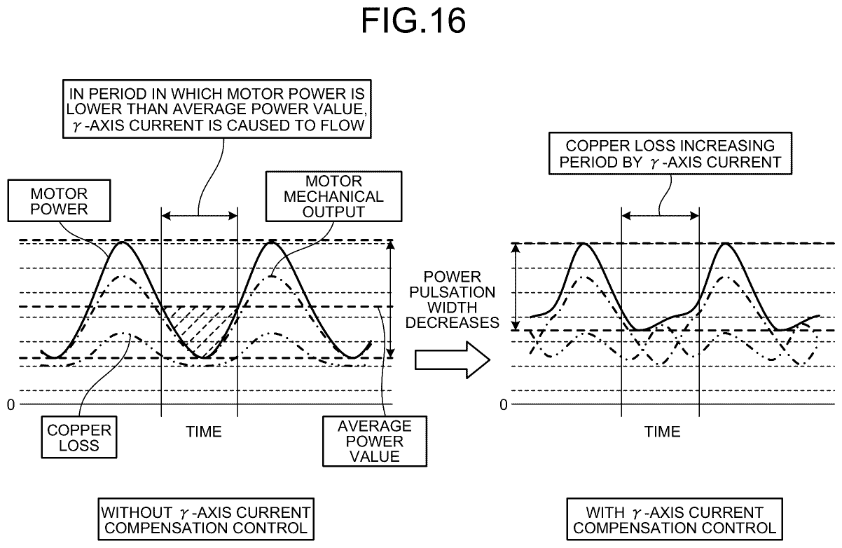

Next, main points of an operation of the γ-axis current compensation unit 504 included in the voltage command value calculation unit 115 according to the first embodiment will be described with reference to FIG. 16. FIG. 16 is a waveform chart for explaining an operation of the γ-axis current compensation unit 504 according to the first embodiment.

The left view of FIG. 16 illustrates a waveform related to the motor power Pm, the motor mechanical output, and the copper loss of the motor 7 in a case where the γ-axis current compensation control is not performed. The case where the γ-axis current compensation control is not performed means that the γ-axis current compensation control function is not activated. In addition, the right view of FIG. 16 illustrates a waveform related to the motor power Pm, the motor mechanical output, and the copper loss of the motor 7 in a case where the γ-axis current compensation control is performed. The case where the γ-axis current compensation control is performed means that the γ-axis current compensation control function is activated. In both views, a solid line represents the motor power Pm, a one-dotted chain line represents the motor mechanical output, and a two-dotted chain line represents the copper loss of the motor 7. Further, a horizontal axis represents time. Note that, in order to prevent activation of the γ-axis current compensation control function, the operation of the γ-axis current compensation unit 504 in FIG. 8 may simply be stopped, or the output of the γ-axis current compensation unit 504 may simply be prevented from being input to the addition unit 506.

As described above, the compressor 8 is a load having torque pulsation. Therefore, speed pulsation and pulsation of the δ-axis current inevitably occur, and as a result, the motor power Pm and the motor mechanical output also pulsate, as illustrated in the left view of FIG. 16. Further, in Equation (4) above, power of the second term on the right side representing the motor mechanical output is dominant as compared with power of the first term on the right side representing the copper loss of the motor 7. Therefore, when the power of the second term on the right side pulsates, the pulsation of the capacitor output current idc also increases, and a harmonic component included in the power-supply current Iin increases.

Therefore, in the first embodiment, in order to reduce the pulsation of the capacitor output current idc, control is performed to increase the copper loss of the motor 7 in a period in which the motor power Pm becomes smaller than the set power value. Note that, in this description, the period during which the motor power Pm becomes smaller than the set power value is appropriately referred to as a “first period”.

Here, as can be understood from the first term and the second term on the right side of Equation (4) above, the copper loss of the motor 7 is increased by increasing the 8-axis current id, but the mechanical output of the motor 7 is also increased. Therefore, in the first embodiment, a technique of increasing the γ-axis current iγ so as to increase the copper loss of the motor 7 is adopted.

The left view of FIG. 16 illustrates an example of a case where the set power value is an average power value Pavg which is an average value of the motor power Pm. Note that the average power value Pavg mentioned here is an average value of the motor power Pm of when the γ-axis current compensation control according to the first embodiment is not performed. Further, in the left view of FIG. 16, a portion surrounded by the motor power Pm and the average power value Pavg is indicated by hatching. A width in a time axis direction of the portion indicated by the hatching corresponds to the above-described first period. In addition, the right view of FIG. 16 illustrates that, by the control of increasing the γ-axis current iγ, in the first period, the copper loss of the motor 7 is increased, a waveform of a downwardly convex portion of the motor power Pm is raised, and a pulsation width of the motor power Pm is reduced.

Note that a direction in which the γ-axis current iγ is caused to flow may be either positive or negative. Since the copper loss of the motor 7 is directly proportional to a square of the current, the copper loss can be generated in the motor 7 in either positive or negative directions. Therefore, in order to increase the copper loss of the motor 7, an absolute value of the γ-axis current iγ may simply be increased.

Further, when the motor 7 is, for example, an embedded permanent magnet motor, the direction in which the γ-axis current iγ is caused to flow is preferably negative. This point will be described below.

In the second term on the right side of Equation (4) above, “(Lγ−Lδ) iγ” is a term representing power related to reluctance torque. When the motor 7 is an embedded permanent magnet motor, a relationship between the γ-axis inductance Lγ and the δ-axis inductance Lδ is generally Lγ<Lδ. This relationship is called “reverse salient pole”. When the motor 7 has the reverse salient pole and the γ-axis current iγ is caused to flow in the negative direction, a value of “(Lγ−Lδ) iγ” becomes positive. Therefore, when the γ-axis current iγ is caused to flow in the negative direction, the value of the reluctance torque becomes positive, so that control is performed in a direction in which driving of the motor 7 is stabilized. As a result, it is possible to lower a possibility that the motor 7 is brought into a step-out state while preventing an increase in a harmonic component of the power-supply current.

In addition, in a case where the power conversion apparatus 2 has a function of flux weakening control and the motor 7 has the reverse salient pole, the γ-axis current iγ is caused to flow in the negative direction when the flux weakening control is performed in an overmodulation region. Therefore, the control of causing the γ-axis current iγ to flow in the negative direction is advantageous for flux weakening control in the motor 7 of the reverse salient pole.

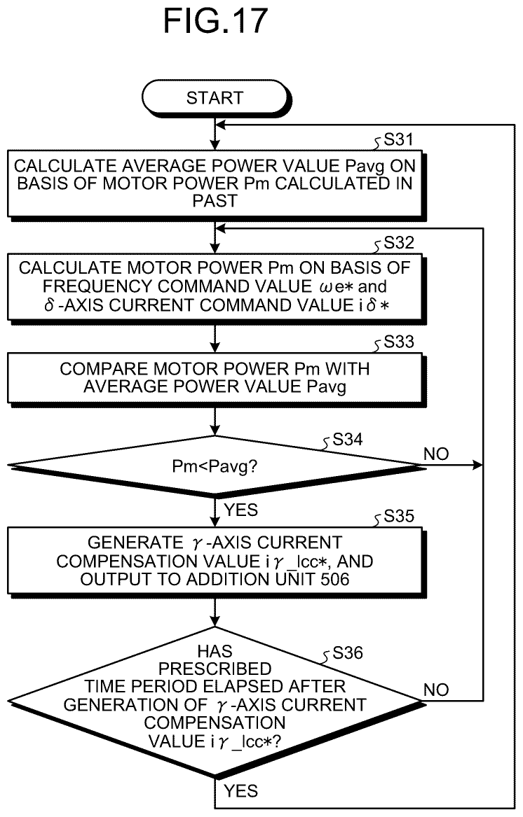

FIG. 17 is a flowchart for explaining an operation of the γ-axis current compensation unit 504 included in the voltage command value calculation unit 115 according to the first embodiment.

In the control device 100, the γ-axis current compensation unit 504 calculates the average power value Pavg on the basis of the motor power Pm calculated in the past (step S31). Further, the γ-axis current compensation unit 504 calculates the motor power Pm this time on the basis of the frequency command value ωe* and the δ-axis current command value iδ* (step S32). Further, the γ-axis current compensation unit 504 compares the motor power Pm with the average power value Pavg (step S33).

When the motor power Pm is not lower than the average power value Pavg (step S34, No), the process returns to step S32, and the processing of steps S32 and S33 is repeated. Whereas, when the motor power Pm is lower than the average power value Pavg (step S34, Yes), the γ-axis current compensation unit 504 generates the γ-axis current compensation value iγ_lcc* and outputs the γ-axis current compensation value iγ_lcc* to the addition unit 506 (step S35). The γ-axis current compensation unit 504 determines whether or not a prescribed time period has elapsed after the generation of the γ-axis current compensation value iγ_lcc* (step S36). When the prescribed time period has not elapsed (step S36, No), the process returns to step S32, and the processing from step S32 is repeated. Whereas, when the prescribed time period has elapsed (step S36, Yes), the process returns to step S31, and the processing from step S31 is repeated.

The above processing will be partially supplemented. In step S35, an absolute value of the γ-axis current compensation value iγ_lcc* output to the addition unit 506 is controlled not to exceed the γ-axis current limit value iγ_lcc_lim* output from the γ-axis current limit value generation unit 540. By performing such control, priority of the γ-axis current compensation control can be lowered with respect to other control, specifically, the vibration reduction control and the flux weakening control. As a result, it is possible to determine the γ-axis current iγ that can be caused to flow to the maximum in the γ-axis current compensation control, while preventing interference with other controls. That is, it is possible to secure the γ-axis current command value iγ** necessary for the flux weakening control, while securing the δ-axis current command value iδ** necessary for the speed control and the vibration reduction control for the motor 7.

Note that, according to the γ-axis current compensation control using the γ-axis current limit value iγ_lcc_lim*, a shape of the γ-axis current compensation value iγ_lcc* is a rectangular wave, but is not necessarily limited to a rectangular wave. The shape of the γ-axis current compensation value iγ_lcc* may be a triangular wave, a trapezoidal wave, or a sine wave whose maximum amplitude is the γ-axis current limit value iγ_lcc_lim*.

Further, the prescribed time period in step S36 can be determined on the basis of a cycle of the motor power Pm and the average power value Pavg. Further, the average power value Pavg in step S31 may be calculated on the basis of the motor power Pm one cycle before, or may be calculated on the basis of the motor power Pm of a plurality of cycles including one cycle before. Further, in step S32, the motor power Pm is calculated on the basis of not a measurement value but the frequency command value ωe* and the δ-axis current command value id* which are command values, so that it is possible to grasp the motor power Pm of when the γ-axis current compensation control is not performed.

Further, in the flowchart of FIG. 17, the γ-axis current compensation value iγ_lcc* is calculated on the basis of the motor power Pm and the average power value Pavg which is an average value of the motor power Pm, but the present disclosure is not limited to this. A rotational speed of the motor 7 may be regarded as being constant, the γ-axis current compensation value iγ_lcc* may be calculated on the basis of the δ-axis current command value id* and an average value thereof. Alternatively, the δ-axis current id of the motor 7 may be regarded as being constant, and the γ-axis current compensation value iγ_lcc* may be calculated on the basis of the frequency estimation value ωest and an average value thereof.

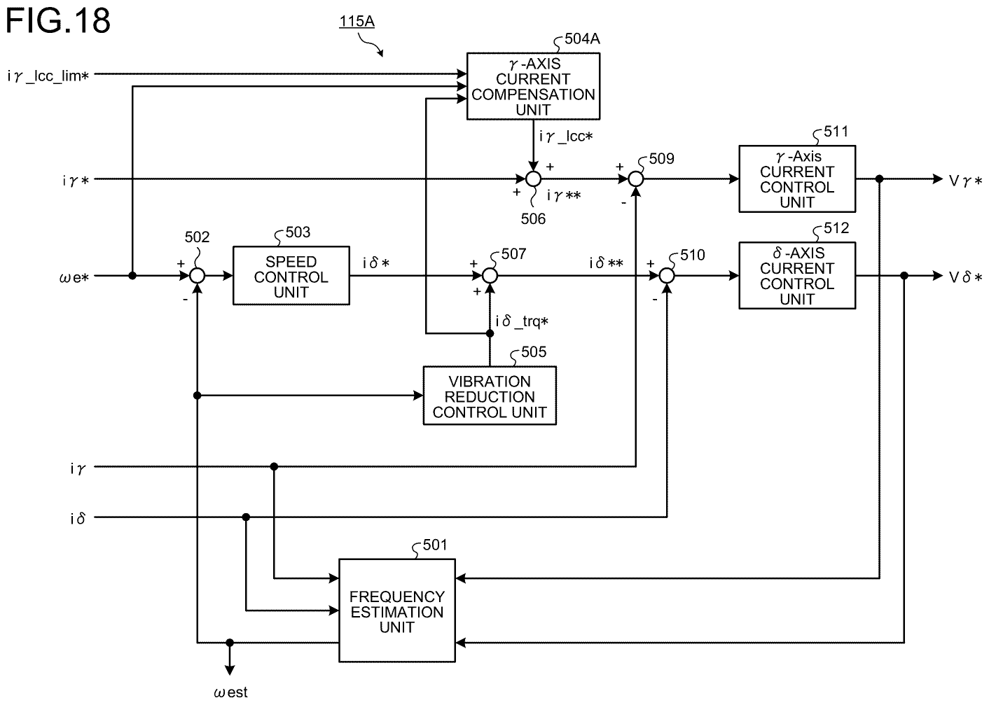

Note that the voltage command value calculation unit 115 according to the first embodiment may be configured as illustrated in FIG. 18. FIG. 18 is a block diagram illustrating a configuration example of a voltage command value calculation unit 115A according to a modification of the first embodiment. In FIG. 18, the γ-axis current compensation unit 504 illustrated in FIG. 8 is replaced with a γ-axis current compensation unit 504A. Further, in the configuration of FIG. 18, an input signal of the γ-axis current compensation unit 504A is changed from the δ-axis current command value id* to the δ-axis current compensation value iδ_trq*. Other configurations are identical or equivalent to the configuration of FIG. 8, and identical or equivalent components are denoted by identical reference numerals, and redundant descriptions are omitted.

In the left diagram of FIG. 16, a case where the motor power Pm is lower than the average power value Pavg is equivalent to a case where the δ-axis current compensation value iδ_trq* becomes negative. Thus, the γ-axis current compensation unit 504A can perform γ-axis current compensation control on the basis of the δ-axis current compensation value iδ_trq*.

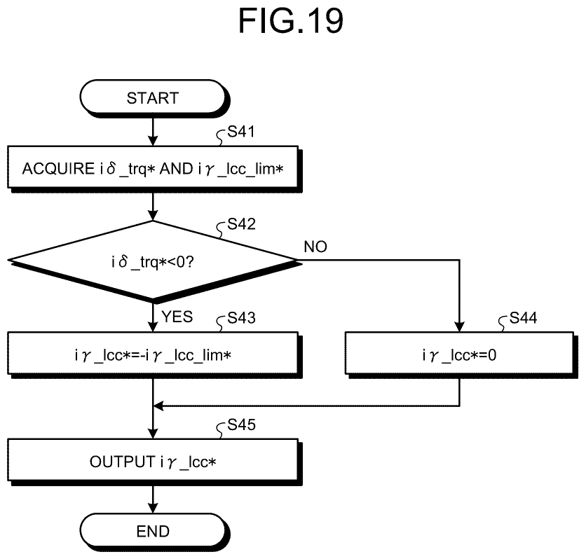

FIG. 19 is a flowchart for explaining an operation of the γ-axis current compensation unit 504A illustrated in FIG. 18.

In the control device 100, the γ-axis current compensation unit 504A acquires the δ-axis current compensation value iδ_trq* and the γ-axis current limit value iγ_lcc_lim* (step S41). When the δ-axis current compensation value iδ_trq* is less than 0, that is, when the δ-axis current compensation value iδ_trq* is negative (step S42, Yes), the γ-axis current compensation unit 504A sets the γ-axis current compensation value iγ_lcc* to the γ-axis current limit value iγ_lcc_lim* (step S43), and outputs the set γ-axis current compensation value iγ_lcc* (step S45). Note that, since a compensation direction of the γ-axis current iγ is negative, the γ-axis current limit value iγ_lcc_lim* is denoted with a minus sign in the processing of step S43. Further, when the δ-axis current compensation value iδ_trq* is 0 or more, that is, when the d-axis current compensation value iδ_trq* is non-negative (step S42, No), the γ-axis current compensation unit 504A sets the γ-axis current compensation value iγ_lcc* to 0 (step S44), and outputs the set γ-axis current compensation value iγ_lcc* (step S45). The above-described effect can also be obtained by the control according to the flowchart illustrated in FIG. 19.

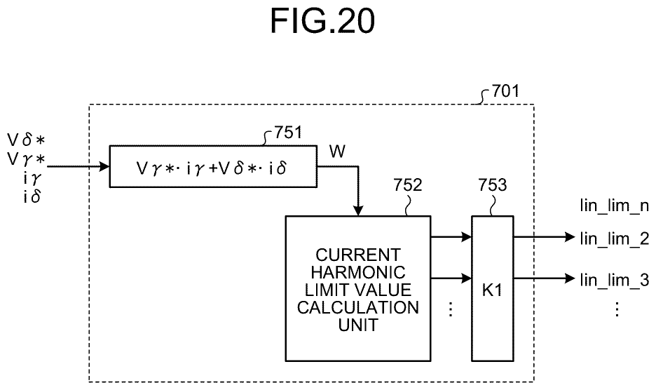

Next, a detailed configuration and operation of the γ-axis current compensation limiting unit 542 will be described. FIG. 20 is a block diagram illustrating a configuration example of the power supply harmonic standard value calculation unit 701 included in the γ-axis current compensation limiting unit 542 according to the first embodiment. The power supply harmonic standard value calculation unit 701 includes a motor power calculation unit 751, a current harmonic limit value calculation unit 752, and a coefficient multiplication unit 753.

First, the motor power calculation unit 751 calculates motor power W by using the above Equation (3). Here, the motor power W is calculated by replacing the γ-axis voltage Vy and the δ-axis voltage Vδ in the Equation (3) with the γ-axis voltage command value Vγ* and the δ-axis voltage command value Vδ*, respectively.

The current harmonic limit value calculation unit 752 calculates a current harmonic limit value on the basis of the motor power W. The coefficient multiplication unit 753 multiplies the current harmonic limit value calculated by the current harmonic limit value calculation unit 752 by a coefficient K1 that determines how much margin is expected for the value. A calculation result by the coefficient multiplication unit 753 is output as the power supply harmonic standard value Iin_lim_n described above.

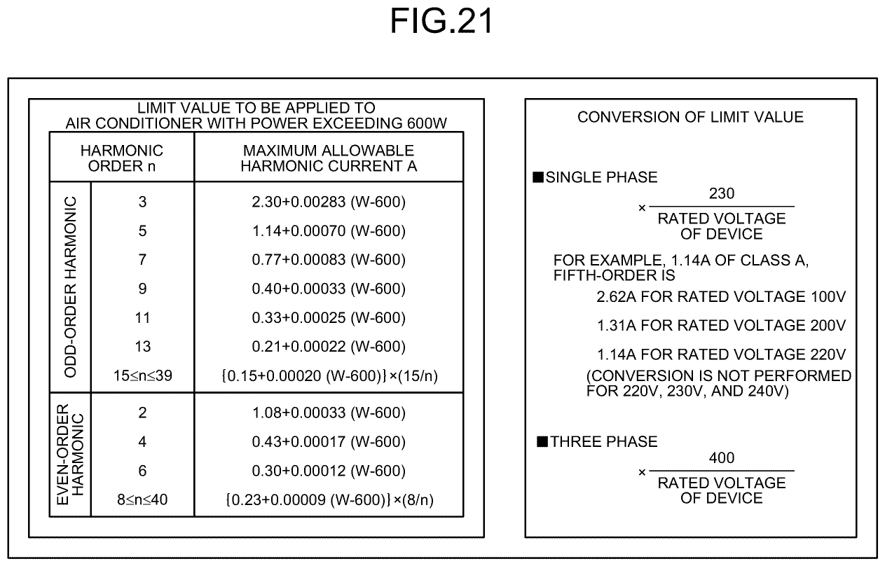

Next, a specific calculation example by the current harmonic limit value calculation unit 752 will be described. FIG. 21 is a view for explaining calculation processing of the current harmonic limit value calculation unit 752 included in the power supply harmonic standard value calculation unit 701 according to the first embodiment. FIG. 21 is a table illustrating a calculation procedure of limit values to be applied to an air conditioner with input power exceeding 600 W specified in JIS_C_61000 March 2. Specifically, the left side of FIG. 21 illustrates a calculation formula of a maximum allowable harmonic current of an odd-order harmonic from the third to the 39th orders, and a calculation formula of a maximum allowable harmonic current of an even-order harmonic from the second to the 40th orders. For example, for the fifth-order maximum allowable harmonic current, the motor power W calculated using Equation (3) above is substituted into the formula “1.14+0.00070 (W−600)”, to calculate the current harmonic limit value. Note that the numerical value “1.14” in the equation is converted using a conversion formula shown in a frame on the right side, on the basis of a rated voltage of the device. As shown in the calculation example, “2.62” is used instead of “1.14” when the rated voltage is 100 V, and “1.31” is used instead of “1.14” when the rated voltage is 200 V. Further, when the rated voltage is 220 V, 230 V, or 240 V, “1.14” is used as it is.

Note that FIG. 21 is an example, and the calculation of the current harmonic limit value is not limited to this example. Instead of the γ-axis voltage command value Vγ* and the δ-axis voltage command value Vδ*, the calculation may be performed using a d-axis voltage command value Vd*, a q-axis voltage command value Vq*, a d-axis current id, and a q-axis current iq. Further, a low pass filter (LPF) may be provided between the motor power calculation unit 751 and the current harmonic limit value calculation unit 752 to remove harmonics included in the calculation value of the motor power W, and then the above-described calculation may be performed. Furthermore, in FIG. 21, the calculation of the second to 40th order harmonic components is performed, but the calculation of the harmonic component exceeding the 40th order may be performed in addition to these harmonic components.

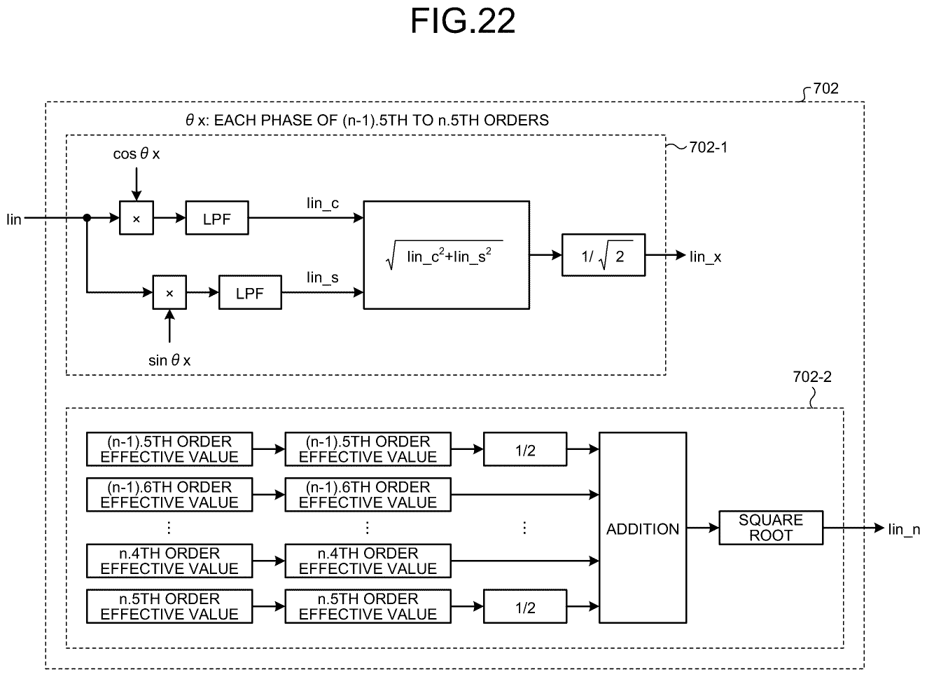

Next, the order component calculation unit 702 will be described. FIG. 22 is a block diagram illustrating a configuration example of the order component calculation unit 702 included in the γ-axis current compensation limiting unit 542 according to the first embodiment. The order component calculation unit 702 includes a first calculation block 702-1 and a second calculation block 702-2.

The first calculation block 702-1 calculates an effective value Iin_x of (n−1).5th to n.5th orders (n is an integer of 2 or more) on the basis of the power-supply current Iin. For example, in a case of n=3, that is, in a case of the third-order harmonic component, (n−1).5th to n. 5th order harmonic components are 11 harmonic components of 2.5th, 2.6th, . . . , 3.0th, . . . , 3.4th, and 3.5th orders. In the first calculation block 702-1, a cosine value cos θx and a sine value sin θx of a phase angle θx synchronized with a frequency of the harmonic component are multiplied by a detection value of the power-supply current Iin, and orthogonal components Iin_c and Iin_s are calculated by passing through a low-pass filter. Furthermore, a root square of the orthogonal components Iin_c and Iin_s is calculated and multiplied by 1/√2, to calculate the effective values Iin_x of (n−1).5th to n. 5th orders.

In the second calculation block 702-2, the effective value Iin_x of each of (n−1).5 to n.5 orders is squared, and a square root of an addition value obtained by adding the square values of the effective value Iin_x is calculated to calculate the order component Iin_n. Note that, in the addition processing, the (n−1).5th and n. 5th order components located at both ends of the 11 harmonic components overlap between adjacent orders, and thus are added after being multiplied by ½.

Note that the calculation example in FIG. 22 is an example, and the calculation of the order component Iin_n is not limited to this example. The calculation may be performed by further finely dividing each harmonic component. Further, similarly to the calculation of the current harmonic limit value, a harmonic component exceeding the 40th order may be calculated.

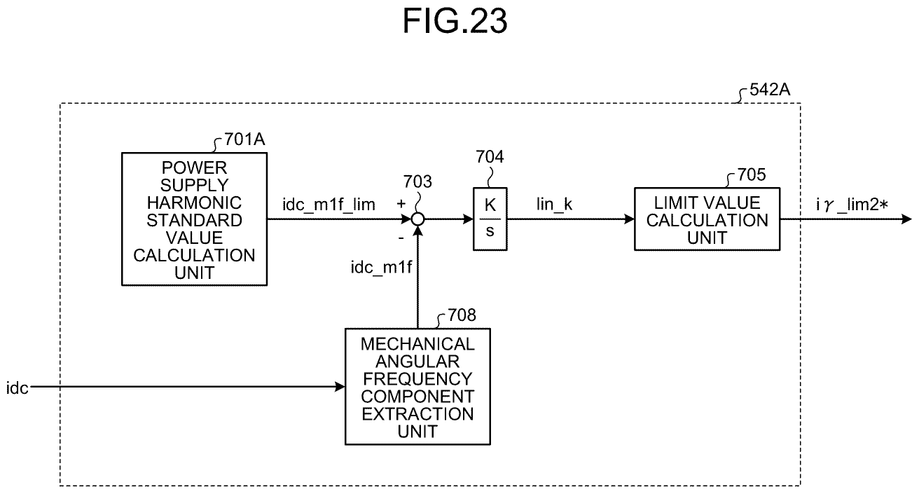

Next, a modification of the γ-axis current compensation limiting unit 542 according to the first embodiment will be described. FIG. 23 is a block diagram illustrating a configuration example of a γ-axis current compensation limiting unit 542A according to a modification of the first embodiment. The γ-axis current compensation limiting unit 542A includes a power supply harmonic standard value calculation unit 701A, the subtraction unit 703, the integration unit 704, the limit value calculation unit 705, and a mechanical angular frequency component extraction unit 708. Note that, components identical or equivalent to those of the γ-axis current compensation limiting unit 542 illustrated in FIG. 12 are denoted by identical reference numerals.

The mechanical angular frequency component extraction unit 708 extracts a mechanical 1f component idc_m1f included in the capacitor output current idc on the basis of the capacitor output current idc acquired from the current detecting unit 84, and outputs the mechanical 1f component idc_m1f to the subtraction unit 703. The “mechanical 1f component” is one time of a mechanical angular frequency of the motor 7, that is, a component of the mechanical angular frequency. When the load of the motor 7 is, for example, a single rotary compressor, the mechanical 1f component is the most dominant frequency component among pulsation components included in the capacitor output current idc.

The power supply harmonic standard value calculation unit 701A calculates a power supply harmonic standard value idc_m1f_lim, and outputs the power supply harmonic standard value idc_m1f_lim to the subtraction unit 703. The power supply harmonic standard value idc_m1f_lim calculated by the power supply harmonic standard value calculation unit 701A is a threshold value for comparison with the mechanical 1f component idc_m1f calculated by the mechanical angular frequency component extraction unit 708.

The power supply harmonic standard value calculation unit 701 illustrated in FIGS. 12 and 15 calculates the power supply harmonic standard value Iin_lim_n on the basis of the γ-axis current iγ, the δ-axis current id, the γ-axis voltage command value Vγ*, and the δ-axis voltage command value Vδ*. Whereas, the power supply harmonic standard value calculation unit 701A illustrated in FIG. 23 generates the power supply harmonic standard value idc_m1f_lim without using a specific input signal. Any technique may be used to generate the power supply harmonic standard value idc_m1f_lim. As an example, it is conceivable, for various loads of the motor 7, to experimentally acquire data of the capacitor output current idc when the loads are driven, and hold a value obtained by analyzing the data in a table. The data held in the table may simply be stored in a memory 202 described later.

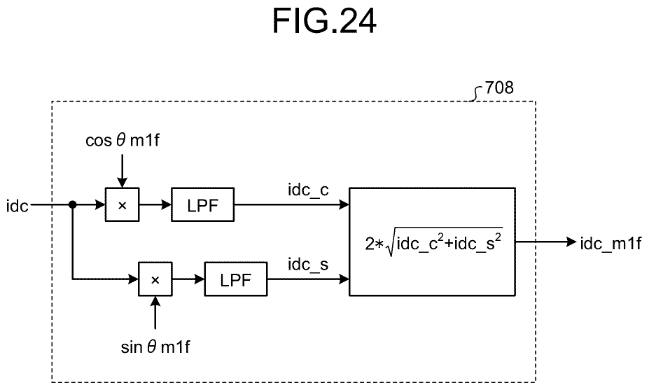

FIG. 24 is a block diagram illustrating a configuration example of the mechanical angular frequency component extraction unit 708 included in the γ-axis current compensation limiting unit 542A according to the modification of the first embodiment. As described above, the mechanical angular frequency component extraction unit 708 extracts the mechanical 1f component idc_m1f included in the capacitor output current idc, on the basis of the capacitor output current idc. In the mechanical angular frequency component extraction unit 708 illustrated in FIG. 24, a cosine value cos θm1f and a sine value sin θm1f of a phase angle θm1f synchronized with a frequency of the mechanical 1f component are multiplied by a detection value of the capacitor output current idc, and orthogonal components idc_c and idc_s are calculated by passing through a low-pass filter. Further, the mechanical 1f component idc_m1f is calculated by multiplying a root square of the orthogonal components idc_c and idc_s by two.

The processing of the mechanical angular frequency component extraction unit 708 in FIG. 24 will be supplemented. Since the capacitor output current idc is a direct current, the capacitor output current idc comes to a half of an actual value in the technique of extracting by multiplying the cosine value cos θm1f and the sine value sin θm1f. Therefore, this value is multiplied by two for the root square of the orthogonal components idc_c and idc_s. In this way, the intended mechanical 1f component idc_m1f is extracted.

Note that, although the mechanical angular frequency component extraction unit 708 in FIGS. 23 and 24 extracts the mechanical 1f component idc_m1f included in the capacitor output current idc, the present disclosure is not limited thereto. In addition to the mechanical 1f component idc_m1f, the mechanical angular frequency component extraction unit 708 may extract a mechanical 2f component which is a component two times of the mechanical angular frequency of the motor 7. By extracting the mechanical 2f component, a spare (or an allowance) can be made in reduction of a harmonic component included in the power-supply current Iin, and an amount of the spare (or the allowance) can be used for the δ-axis current command of the vibration reduction control or the γ-axis current command of the flux weakening control.

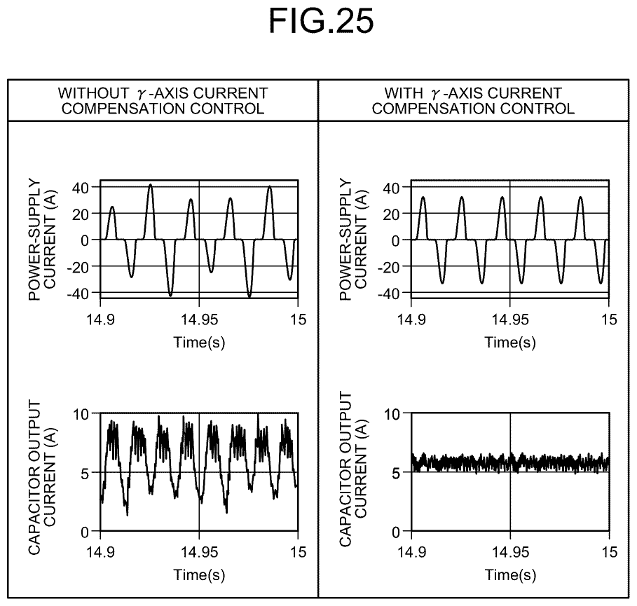

FIG. 25 is a view for explaining an effect of the γ-axis current compensation control according to the first embodiment. The left part of FIG. 25 illustrates a waveform of a power-supply current and a capacitor output current of when the γ-axis current compensation control is not performed. Further, the right part of FIG. 25 illustrates a waveform of the power-supply current and the capacitor output current of when the γ-axis current compensation control is performed.

When the γ-axis current compensation control is not performed, pulsation of the capacitor output current becomes large as illustrated in the left part of FIG. 25. This shows that a peak value of the power-supply current fluctuates and a harmonic component included in the power-supply current increases. On the other hand, when the γ-axis current compensation control is performed, pulsation of the capacitor output current becomes small as illustrated in the right part of FIG. 25. This shows that a peak value of the power-supply current becomes substantially constant, and a harmonic component included in the power-supply current is reduced.

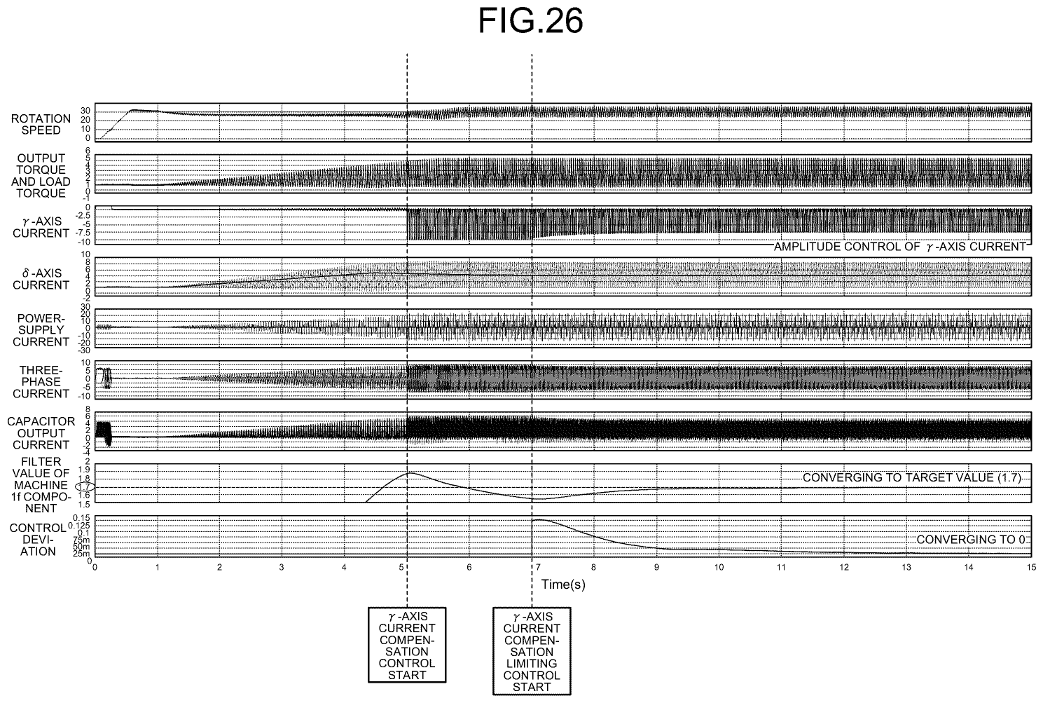

FIG. 26 is a view for explaining an action by the γ-axis current compensation limiting control according to the first embodiment. Specifically, FIG. 26 illustrates waveforms of a rotation speed of the motor 7, an output torque and a load torque of the motor 7, a γ-axis current, a δ-axis current, a power-supply current, a three-phase current, a capacitor output current, a filter value of the mechanical 1f component, and a control deviation in order from the upper side. The control deviation is a deviation of the γ-axis current compensation limiting control. Note that a horizontal axis represents time.

Focusing on the third waveform from the top in FIG. 26, an amplitude of the γ-axis current iγ is set to −10 [A] by starting of the γ-axis current compensation control, and an amplitude of the γ-axis current iγ is limited to −7.5 [A] by the γ-axis current compensation limiting control thereafter. Further, focusing on the second waveform from the bottom, it can be seen that the filter value of the mechanical 1f component converges to 1.7, which is a target value, after about nine seconds from activation, that is, after about two seconds from the starting of the γ-axis current compensation limiting control. Further, focusing on the lowermost waveform, it can be seen that the control deviation converges to a value of approximately 0 after about 12 seconds from activation, that is, after about five seconds from the starting of the γ-axis current compensation limiting control. From these operation waveforms, it can be seen that the γ-axis current compensation limiting control is effective and operates stably.

As described above, according to the power conversion apparatus of the first embodiment, the control device includes the excitation current compensation unit and the excitation current compensation limiting unit. The excitation current compensation unit performs excitation current compensation control for reducing pulsation of the capacitor output current output from the capacitor to the inverter, when vibration reduction control of reducing vibration of the load is performed. With this control, it is possible to prevent the power-supply current from being in an imbalance state between positive and negative polarities, and it is possible to prevent an increase in harmonic component that can be included in the power-supply current. Further, when the excitation current compensation control is performed, the excitation current compensation limiting unit performs the excitation current compensation limiting control of limiting an excitation current compensation value generated by the excitation current compensation unit so as to reduce a harmonic component included in the power-supply current flowing between the AC power supply and the converter. This makes it possible to prevent an increase in harmonic component of the power-supply current while compensating for torque pulsation of the motor.

Note that the excitation current compensation control described above can be achieved by causing a loss in the motor in the first period in which motor power, which is power supplied from the inverter to the motor, becomes smaller than a set power value. The set power value may be an average value of the motor power of when the first control is not performed. Further, the excitation current compensation control can also be achieved by causing a loss in the motor in the first period in which a torque current compensation value for reducing vibration of the load becomes a negative value.

Further, the limit value for limiting the excitation current compensation value can be generated on the basis of a harmonic component of the power-supply current or a mechanical angular frequency component of the capacitor output current output from the capacitor to the inverter. By limiting the excitation current compensation value by using this limit value, an imbalance state between positive and negative of the power-supply current is prevented, so that it is easy to conform to the power supply harmonic standard. This eliminates the need to change or modify a circuit constant of the converter and a switching method of the converter, so that an inexpensive and highly reliable motor driving device can be obtained. In addition, since a power supply power factor also increases due to the reduction of the power supply harmonics, it is no longer necessary to cause a useless current to flow. As a result, efficiency on the converter side can be increased.

Furthermore, according to the power conversion apparatus according to the first embodiment, conforming to the power supply harmonic standard is performed by automatic control of the control device. Therefore, adjustment regarding the converter and the circuit constants around the converter is simplified, and it is possible to obtain a motor driving device that is inexpensive, highly reliable, and has a small development load.

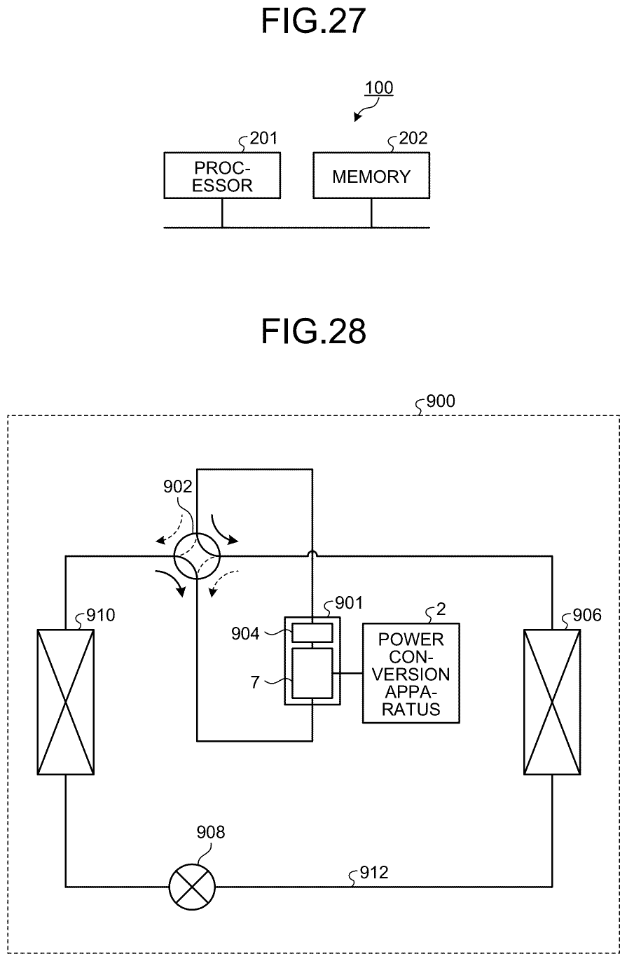

Next, a hardware configuration of the control device 100 included in the power conversion apparatus 2 will be described. FIG. 27 is a diagram illustrating an example of a hardware configuration for implementing the control device 100 included in the power conversion apparatus 2 according to the first embodiment. The control device 100 is implemented by a processor 201 and the memory 202.

The processor 201 is a central processing unit (CPU) (may also be referred to as a central processing device, a processing unit, an arithmetic unit, a microprocessor, a microcomputer, a processor, or a digital signal processor (DSP)) or a system large scale integration (LSI). The memory 202 can be exemplified by a nonvolatile or volatile semiconductor memory such as a random access memory (RAM), a read only memory (ROM), a flash memory, an erasable programmable read only memory (EPROM), or an electrically erasable programmable read-only memory (EEPROM) (registered trademark). In addition, the memory 202 is not limited thereto, and may be a magnetic disk, an optical disk, a compact disk, a mini disk, or a digital versatile disc (DVD).

### Second Embodiment

FIG. 28 is a diagram illustrating a configuration example of a refrigeration cycle application device 900 according to a second embodiment. The refrigeration cycle application device 900 according to the second embodiment includes the power conversion apparatus 2 described in the first embodiment. The refrigeration cycle application device 900 according to the second embodiment can be applied to a product including a refrigeration cycle, such as an air conditioner, a refrigerator, a freezer, or a heat pump water heater. Note that, in FIG. 28, components having functions similar to those of the first embodiment are denoted by reference numerals identical to those of the first embodiment.

The refrigeration cycle application device 900 includes a compressor 901 incorporating the motor 7 according to the first embodiment, a four-way valve 902, an indoor heat exchanger 906, an expansion valve 908, and an outdoor heat exchanger 910, which are attached via a refrigerant pipe 912.

Inside the compressor 901, a compression mechanism 904 that compresses a refrigerant, and the motor 7 that operates the compression mechanism 904 are provided.

The refrigeration cycle application device 900 can perform heating operation or cooling operation by a switching operation of the four-way valve 902. The compression mechanism 904 is driven by the motor 7 subjected to variable-speed control.

During the heating operation, as indicated by solid arrows, the refrigerant is pressurized and fed by the compression mechanism 904, and returns to the compression mechanism 904 through the four-way valve 902, the indoor heat exchanger 906, the expansion valve 908, the outdoor heat exchanger 910, and the four-way valve 902.

During the cooling operation, as indicated by broken arrows, the refrigerant is pressurized and fed by the compression mechanism 904, and returns to the compression mechanism 904 through the four-way valve 902, the outdoor heat exchanger 910, the expansion valve 908, the indoor heat exchanger 906, and the four-way valve 902.

During the heating operation, the indoor heat exchanger 906 acts as a condenser to release heat, and the outdoor heat exchanger 910 acts as an evaporator to absorb heat. During the cooling operation, the outdoor heat exchanger 910 acts as a condenser to release heat, and the indoor heat exchanger 906 acts as an evaporator to absorb heat. The expansion valve 908 decompresses and expands the refrigerant.

The configuration illustrated in the above embodiment illustrates one example and can be combined with another known technique, and it is also possible to omit and change a part of the configuration without departing from the subject matter.

1. A power conversion apparatus that supplies alternating-current power to a motor, the motor driving a load, the power conversion apparatus comprising:
a converter rectifying a power-supply voltage applied from an alternating-current power supply;
a capacitor connected to an output end of the converter;
an inverter connected across the capacitor; and
control circuitry performing vibration reduction control of reducing vibration of the load by controlling an operation of the inverter, wherein
the control circuitry comprises:
excitation current compensation circuitry reducing pulsation of a capacitor output current output from the capacitor to the inverter; and
excitation current compensation limiting circuitry limiting an excitation current compensation value generated by the excitation current compensation circuitry so as to reduce a harmonic component contained in a power-supply current flowing between the alternating-current power supply and the converter.

2. The power conversion apparatus according to claim 1, wherein
the excitation current compensation circuitry causes a loss in the motor in a first period in which motor power that is power supplied from the inverter to the motor becomes smaller than a set power value.

3. The power conversion apparatus according to claim 1, wherein
the excitation current compensation circuitry causes a loss in the motor in a first period in which a torque current compensation value for reducing vibration of the load becomes a negative value.

4. The power conversion apparatus according to claim 1, wherein
the excitation current compensation limiting circuitry generates a limit value for limiting the excitation current compensation value, based on a harmonic component of the power-supply current.

5. The power conversion apparatus according to claim 4, wherein
the limit value is calculated based on a power supply harmonic standard value and an order component of the harmonic component, the power supply harmonic standard value being a threshold value for determining whether a specific frequency component satisfies a power supply harmonic standard, and the order component being calculated based on the power-supply current.

6. The power conversion apparatus according to claim 1, wherein
the excitation current compensation limiting circuitry generates a limit value for limiting the excitation current compensation value, based on a mechanical angular frequency component of a capacitor output current output from the capacitor to the inverter.

7. The power conversion apparatus according to claim 6, wherein
the limit value is calculated based on a power supply harmonic standard value and the mechanical angular frequency component, the power supply harmonic standard value being a threshold value for determining whether a specific frequency component satisfies a power supply harmonic standard, and the mechanical angular frequency component being extracted based on the capacitor output current.

8. The power conversion apparatus according to claim 1, wherein
the control circuitry comprises:
command value generation circuitry generating an excitation current command value based on a torque current or an excitation current, and
the excitation current compensation value is superimposed on the excitation current command value.

9. A motor driving device comprising the power conversion apparatus according to claim 1.

10. A refrigeration cycle application device comprising the power conversion apparatus according to claim 1.

11. The power conversion apparatus according to claim 2, wherein
the excitation current compensation limiting circuitry generates a limit value for limiting the excitation current compensation value, based on a harmonic component of the power-supply current.

12. The power conversion apparatus according to claim 3, wherein
the excitation current compensation limiting circuitry generates a limit value for limiting the excitation current compensation value, based on a harmonic component of the power-supply current.

13. The power conversion apparatus according to claim 2, wherein
the excitation current compensation limiting circuitry generates a limit value for limiting the excitation current compensation value, based on a mechanical angular frequency component of a capacitor output current output from the capacitor to the inverter.

14. The power conversion apparatus according to claim 3, wherein
the excitation current compensation limiting circuitry generates a limit value for limiting the excitation current compensation value, based on a mechanical angular frequency component of a capacitor output current output from the capacitor to the inverter.
